(19) United States
(12) Patent Application Publication
(10) Pub. No.: US 2002/0008690 A1
(43) Pub. Date: Jan. 24, 2002

(54) Customizable interactive binders and methods for customizing the same

(76) Inventor: Kenneth Cooper, Irvine, CA (US)

Correspondence Address: Eric K. Satermo, Registered Patent Agent, P. O. Box 19099, Irvine, CA, 92623-9099, US

(21) Appl. No.: 09/732,521

(22) Filed: Dec. 6, 2000

Related U.S. Application Data
(63) Continuation-in-part of application No. 09/455,278, filed on Dec. 6, 1999.

(51) Int. Cl. G09G 5/00

(52) U.S. Cl. 345/156

(57) ABSTRACT

A computer-interactive binder is disclosed for causing an execution of a user-programmable function by an remote computer, network or other digital device, comprising a spine having first and second sides, a front cover pivotably coupled to the first side of the spine, a back cover pivotably coupled to the second side of the spine, a binding mechanism attached to either of the spine, front cover or back cover, an input device, and in some cases, a microprocessor for causing the remote computer, network or other digital device to execute the user-programmable function in response to the input device. Additionally, a computer-interactive binder insert is disclosed for causing an execution of a user-programmable function by a remote computer, network or digital device, comprising a relatively flat member having openings for mating with a binder mechanism, an input device incorporated into the flat member, and a microprocessor for causing the remote computer, network or other digital device to execute the user-programmable function in response to the input device. A computer-interactive document holding apparatus is also disclosed for causing an execution of a user-programmable function by a remote computer, network or digital device, comprising a container for holding at least one physical document, an input device incorporated into the container, and a microprocessor incorporated into the container for causing the remote computer, network or other digital device to execute the user-programmable function in response to the input device.

### CROSS-REFERENCE TO RELATED APPLICATION

This application is a continuation-in-part (CIP) application of U.S. patent application Ser. No. 09/455,278 filed Dec. 6, 2000 the entire disclosure of which is incorporated herein by reference.

### FIELD OF THE INVENTION

This invention relates generally to notebook binders and, in particular, to binders that interactively interface with a computer, a network, or other digital device to perform various user programmable functions. The invention also relates to interactive binders that are customizable by a user for a particular application. For example, the interactive binders of the present invention can be customize for training or instructing personnel in a particular subject, or for presenting a desired set of information.

### BACKGROUND OF THE INVENTION

The technological advancements in recent years in the computer, network and telecommunication fields have been astronomical. These advancements have been so prevalent, that computers, networks and telecommunication equipment are an everyday and even essential part of many peoples' lives. Most, if not all, business establishments, educational institutions and governmental entities at least use some computers, networks and telecommunication equipment in their daily operations. Nowadays, it would be surprising for a credible institution not to use some degree of computers, networks and telecommunication equipment.

One aspect of technology driving the technological advancements in the computer, network and telecommunication fields is the emergence of the Internet. The Internet is a worldwide network of computers that provides a medium for the communication of digital information throughout the whole world. Because the Internet is capable of digitally communicating with a wide audience throughout the world, the amount of information accessible through the Internet has exploded. Business establishments have created websites to provide information about their products and/or services, educational institutions have created websites to provide information about their studies, research and discoveries, and governmental institutions have also created websites to provide information about their laws, rules, regulations, and governmental services. In essence, the recent widespread acceptance of the Internet has made it an essential daily part of peoples' lives.

Although computers in general and the Internet in particular have obtained widespread acceptance throughout the world, many people still rely on physical documents to keep track of and store information. The notebook binder is an indispensable tool for storing and organizing physical documents, containing information. For one thing, notebook binders are easily accessible and portable. For another thing, notebook binders have been an accepted tool for storing and organizing information for centuries. Additionally, notebook binders provide an almost permanent means for storing information, whereas information stored in a computer medium is more susceptible of being lost due to electronic failure or user error. Thus, notebook binders will most certainly be an indispensable tool for many years to come, even though there are new technological mediums for storing and organizing information.

Because of the widespread use of computers/Internet for obtaining and displaying information and the widespread use of notebook binders for storing and organizing information, it would be desirable for a notebook binder that can interactively interface with a computer, the Internet or other digital devices to provide information on a display screen that relates to information written on physical documents organized in a notebook binder. Such a computer interactive notebook binder can be used to make presentation, to supplement physical reports stored in the binder with digital information stored in a computer and/or network system, or to interact with a training or other software program relating to the physical documents stored in the binder.

In view of the foregoing, there is a need in the art for an interactive notebook binder that can be customized by a user to carry out a particular function, such as for training or for presentation purposes.

### SUMMARY OF THE INVENTION

Other aspects, features, and advantages of the present invention will become apparent to those skilled in the art from a consideration of the following detailed description taken in conjunction with the accompanying drawings.

### BRIEF DESCRIPTION OF THE DRAWINGS

FIG. 1 illustrates a block diagram of a computer system that uses a computer-interactive binder in accordance with the invention;

FIG. 2 illustrates a block diagram on another computer system that uses a computer-interactive binder in accordance with the invention;

FIG. 3 illustrates an exemplary embodiment of a computer-interactive binder in accordance with the invention;

FIG. 4 illustrates a flowchart of an exemplary software program in accordance with the invention that can be used to pre-assign functions to keyboard switches of the computer-interactive binder;

FIG. 5 illustrates a flowchart of an exemplary software program in accordance with the invention that can execute a function assigned to an activated switch on the computer-interactive binder;

FIG. 6 illustrates an exemplary computer-interactive binder in accordance with the invention that has a plurality of dividers having respective tabs overlying switches of the binder keyboard;

FIG. 7 illustrates an exemplary computer-interactive binder in accordance with the invention that has a keyboard comprising a two-dimensional array of switches;

FIG. 8 illustrates an exemplary computer-interactive binder in accordance with the invention that has a plurality of dividers having respective tabs overlying an outer column of switches of a keyboard comprising a two-dimensional array of switches;

FIG. 9 illustrates an exemplary computer-interactive binder in accordance with the invention having an input device comprising a force sensitive resistor (FSR) pad;

FIG. 10 illustrates an exemplary computer-interactive binder in accordance with the invention having an input device comprising an FSR pad and an array of switches, and a plurality of dividers having respective tabs overlying respective switches;

FIG. 11 illustrates an exemplary computer-interactive binder in accordance with the invention having an input device comprising a radio frequency identification (RFID) reader and attached antenna;

FIG. 12 illustrates an exemplary computer-interactive binder in accordance with the invention having random placed RFID tags disposed on a bounded physical document, wherein the binder includes an input device comprising an RFID reader and attached antenna;

FIG. 12A illustrates a block diagram of an external RFID reader/computer-communicating circuit for communicating digital information between a computer-interactive binder and a remote computer, network or other digital device;

FIG. 12B illustrates a block diagram of an external RFID reader/computer-communicating circuit and RFID wand functions as an external RFID antenna, for communicating digital information between a computer-interactive binder and a remote computer, network or other digital device;

FIG. 13 illustrates an exemplary computer-interactive pad in accordance with the invention that incorporates an RFID reader;

FIG. 14 illustrates a computer-interactive binder insert in accordance with the invention;

FIG. 15 illustrates a plurality of computer-interactive binder inserts in accordance with the invention that can be bounded within a notebook binder in a stacked manner;

FIGS. 16A and 16B illustrate portions of computer-interactive binder inserts having overlying and offset switches, respectively;

FIG. 17 illustrates a computer-interactive interlocking member in accordance with the invention for attachment to a binder;

FIGS. 18A and 16B illustrate perspective and broken views of the preferred assembly of a computer-interactive binder in accordance with the invention;

FIGS. 19A-19C illustrate front perspective, back perspective and front broken views of the preferred assembly of a computer-interactive binder insert in accordance with the invention;

FIG. 20 illustrates an exemplary computer-interactive binder in accordance with the invention having a keyboard that includes two sets of color-coded, push-button switches;

FIG. 21A depicts a block diagram illustrating a conventional passive RF tag;

FIG. 21B depicts a block diagram illustrating additional details of a typical passive RF tag;

FIGS. 22A-22C depict state diagrams illustrating changes of state of various implementations of interactive RF tags in accordance with preferred embodiments of the present invention;

FIGS. 23-30 depict simplified block diagrams illustrating various implementations of interactive RF tags in accordance with preferred embodiments of the present invention;

FIG. 31A-31D illustrate examples of broad categories of applications for the computer-interactive binder of the invention for different environments;

FIG. 32 illustrates a table depicting how a computer-interactive binder in accordance with the invention can be organized for a real estate application;

FIG. 33 illustrates a table depicting how a computer-interactive binder in accordance with the invention can be organized for a sales meeting application;

FIG. 34 is a schematic block diagram of a customizable interactive binder system in accordance with the present invention;

FIG. 35 is a flowchart illustrating exemplary steps in preferred methodology for customizing an interactive binder of the present invention;

FIG. 36 is a schematic plan view of page of a binder with content divided into a plurality of elements each associated with a switch; and

FIG. 37 is a flowchart illustrating exemplary steps in preferred methodology for utilizing a customized interactive binder of the present invention.

### DETAILED DESCRIPTION OF THE PREFERRED EMBODIMENTS

I. Computer Systems Having a Computer-Interactive Binder

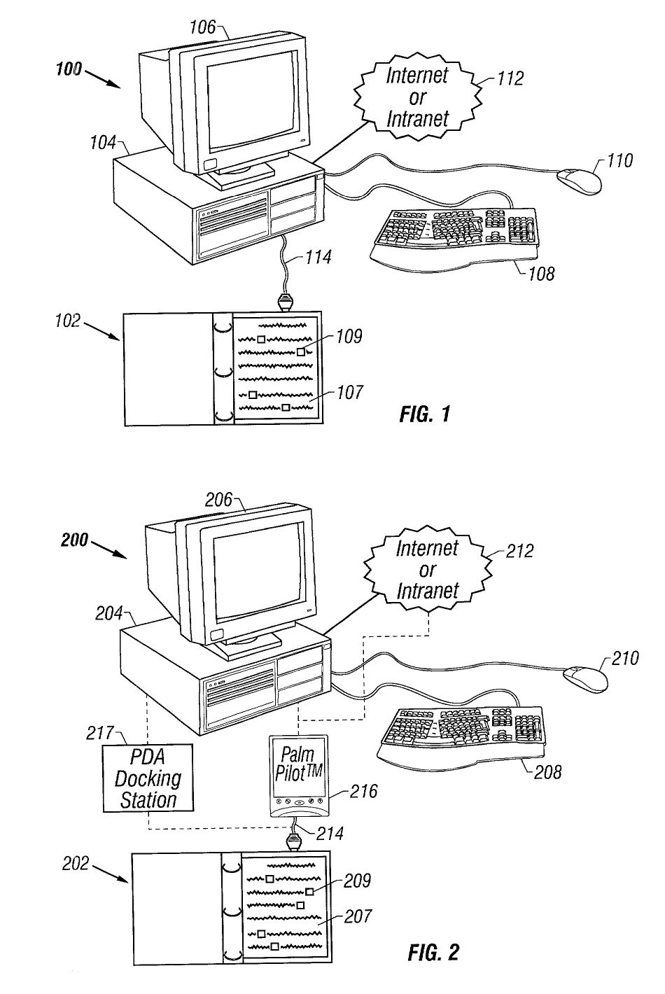

FIG. 1 illustrates a block diagram of a computer system 100 that uses a computer-interactive binder 102 in accordance with the invention. The computer system 100 preferably comprises a computer 104 having a display screen 106, and data entry mechanisms such as keyboard 108 and mouse or track ball 110. The computer 104 may be connected or have the capability of being connected to a network of computers, such as an Internet or an intranet 112. The computer-interactive binder 102 may be connected to the computer 104 via a cable 114, such a serial cable, a universal serial bus (USB) cable, or a parallel cable. Although a physical cable 114 is shown in FIG. 1, it shall be understood that wireless communication can be used to digitally connect the computer-interactive binder with the remote computer, network or other digital device for all embodiments described herein. An example of a wireless protocol that can be used to interface the computer-interactive binder 100 with different digital devices is Blue Tooth, which is recently gaining popularity in the computer field. As is customary, the computer-interactive binder 102 may include organized physical documents containing particular types of information.

The computer-interactive binder 102 may be used to communicate with the computer 104 or with the internet or intranet 112 by way of the computer 104 to perform many user-programmable functions. The computer-interactive binder 102 has an input device (e.g., a keyboard) which a user can use to communicate with the computer 104. The user may preprogram the keys on the computer-interactive binder 102 so that the computer 104 performs desired functions. For example, the user may program a key to cause the computer 104 to download a particular website from the internet. Or, the user may program another key to cause the computer 104 to open a software program. Additionally, the user may program another key to cause the computer 104 to produce a picture, a graph or other visual information on the display screen 106. There are many applications that a user can launch on the computer 104 through the use of the computer-interactive binder 102.

Computer-interactive binder 102 is designed to bind physical documents 107 as is well known in the case of loose-leaf binders and other types of binders. Binder 102 incorporates a series of link devices 109 which serve to trigger interactions between the binder 102 and the computer 104 and/or the internet or intranet 112. As explained herein, these interactions can link the physical documents or printed information on such documents, to information on computer 104 or on internet or intranet 112. Such physical-to-electronic links are a principle function of the computer-interactive binders of the invention.

In the computer-interactive binder 102 of FIG. 1, the link devices 109 are incorporated in the binder itself at various predetermined, fixed locations. Another principle approach, shown in FIG. 1, uses linked devices in the form of tags 109 which are placed by the user at desired locations on the binder 102 or on physical documents 107 contained in the binder. Various embodiments of fixed-location and variable-location devices are described below.

FIG. 2 illustrates a block diagram of another computer system 200 that uses a computer-interactive binder 202 in accordance with the invention. The computer system 200 is similar to computer system 100 including many of the same elements, such as a computer 204, a display screen 206, a keyboard 208, and a mouse or a track ball 210. The computer 204 may be connected to an internet or intranet 212. The computer system 200 differs from computer system 100 in that the former includes a computer-interactive binder 202 coupled to a personal digital assistant (PDA) device 216, such as a palm pilot™ or the like. The computer-interactive binder 202 may interact with the PDA 216 to cause it to perform a desired function. The PDA 216 can also be used to assign PDA functions to the keys of the computer-interactive binder 200. The PDA 216 may be connected directly to the computer 204 or directly to the intranet or internet 212. Alternatively, the computer-interactive binder 202 may also be connected to a PDA docking station 217, which is in turn, connected to the computer 204. It shall be understood that the computer-interactive binder 200 can interface with other digital devices, which could also be connected to the Internet or an intranet.

II. Computer-Interactive Binder Using Switch Technology

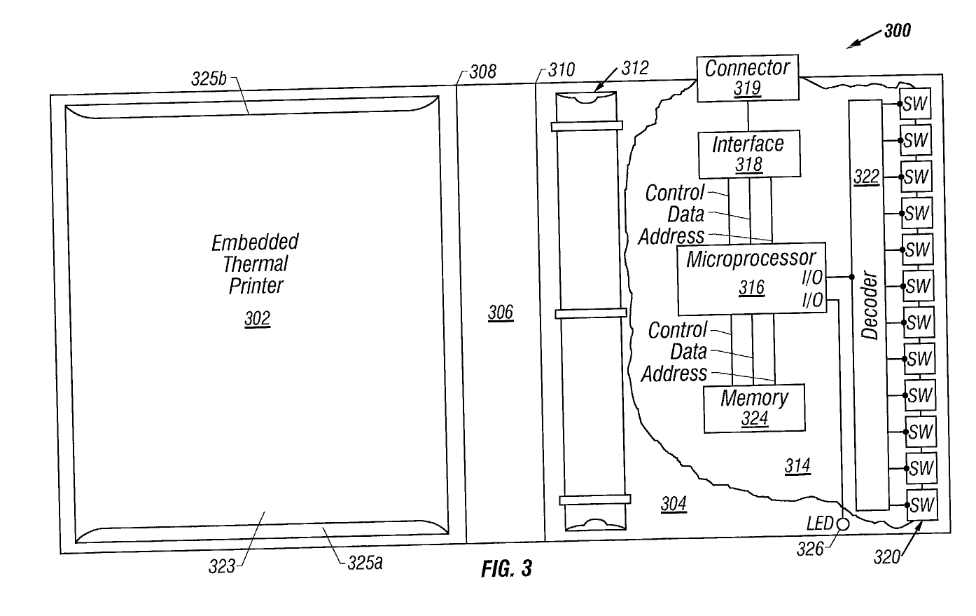

FIG. 3 illustrates an exemplary embodiment of a computer-interactive binder 300 in accordance with an aspect of the invention. As typical of most binders, the computer-interactive binder 300 comprises a front cover 302 and a back cover 304 that are both pivotably coupled to a spine 306 by way of respective transverse hinge lines 308 and 310. The computer-interactive binder 300 further comprises a binder mechanism 312 which can be mounted on the back cover 304 as shown in FIG. 3, or on the spine 306. The binder style shown in FIG. 3 is used merely to exemplify the invention, and not to limit the invention to any particular type of binder. It shall be understood that many types of binders can be configured in a computer-interactive manner in accordance with the invention as will be described herein.

To make the binder 300 computer-interactive, the binder 300 incorporates a digital communicating circuit 314 which allows a user to interact with a remote computer, network or other digital devices. In the preferred embodiment, the digital communicating circuit 314 is embedded within the back cover 304 of the binder 300. It shall be understood that the digital communicating circuit 314 can be incorporated within other elements of the binder 300. For example, the digital communicating circuit 314 can be incorporated within the spine 306, the front cover 302, or even within the binder mechanism 312. For aesthetic purposes, it is preferred that the digital communicating circuit 314 be incorporated into the binder in a manner that most of the physical electronics of the digital communicating circuit 314 be hidden from plain view.

In the preferred embodiment, the digital communicating circuit 314 comprises a microprocessor 316 coupled to a computer interface 318, such as a serial interface or a universal serial bus (USB) interface. The microprocessor 316 is coupled to the computer interface 316 by way of digital lines, such as control, data, and address lines. Depending on the microprocessor used, the address line connecting the microprocessor 316 to the interface 318 need not be present. The computer interface 316 is, in turn, coupled to a connector 319 that connects with a computer interface cable (not shown). The microprocessor 316 is coupled to a keyboard 320 comprising a one-dimensional array of switches (SW) which are preferably aligned along the outer transverse edge of the back cover 304. The switches can be of many types, including thermal, capacitive and optical types. The microprocessor 316 may be coupled directly to the keyboard 320, or may be coupled thereto by way of a decoder 322. Optionally, the digital communicating circuit 314 may include a separate volatile or non-volatile memory circuit 324 used for storing programs or data. The memory circuit 324 is coupled to the microprocessor 316 by way of control, data and address bus. The computer-interactive binder 300 may also include a light emitting diode (LED) 326 or other visual indicator to indicate to the user that the digital communicating circuit 314 is in operation.

In operation, a user of the computer-interactive binder 300 activates a desired switch (SW) of the keyboard 320. In response, the microprocessor 316 determines which switch (SW) was activated and generates a digital code corresponding to the activated switch. The digital code is then communicated to a remote computer, network or other digital device by way of interface 318, connector 319, and computer interface cable (not shown). Then, the remote computer, network or other digital device reads the digital code assigned to the activated switch (SW) and uses a look-up table to perform a pre-assigned user programmable function, such as opening a new software application, accessing a particular website, or displaying some desired information. The user-programmable functions assigned to respective switches (SW) can be pre-programmed by a user through the remote computer, network or digital device.

In the case where there are many computer-interactive binders 300 interfacing with a computer, network or digital device, there would be a need for the system to distinguish one binder from another. If such were the case, the microprocessor 316 must also send a code to the remote computer, network or digital device that identifies the binder. This code may be separate from the code identifying the switch (SW), or may be integral therewith. In this case, the remote computer, network or digital device identifies the particular binder, and then performs the user-programmable function in accordance with the code corresponding to the activated switch (SW).

Alternatively, instead of the microprocessor 316 generating a code that identifies the activated switch (SW), the microprocessor 316 can generate a command to instruct the remote computer, network or digital device to perform a particular function. More specifically, when a user activates a particular switch (SW), the microprocessor 316 determines which switch (SW) has been activated and then uses a look-up table to find a corresponding command to send to the remote computer, network or other digital device. For instance, the command generated by the microprocessor may consist of a URL address for a particular website the user would like to view on the computer display screen. The look-up table having the commands assigned to the switches (SW) may be stored in the memory circuit 324, which may be non-volatile to permanently maintain the look-up table during power down. The commands stored in the look-up table in memory circuit 324 may be set by a user through the remote computer, network or other digital device, and then downloaded from these remote digital devices and stored in the memory circuit 324.

The computer-interactive binder 300 may also include a thermal printer 323 preferably embedded in the front cover 302, or alternatively, embedded in the rear cover 304. Suitable interface circuitry (not shown) may be provided to establish a digital communication link between the microprocessor 316 and the thermal printer 302. The thermal printer 323 may include a manual feed input 325a for feeding in paper to which printing thereon is desired, and an output 325b to feed out the paper once it has been printed. The thermal printer 323 can be incorporated into the various binder embodiments described herein, and also a binder-supporting pad discussed later in this disclosure.

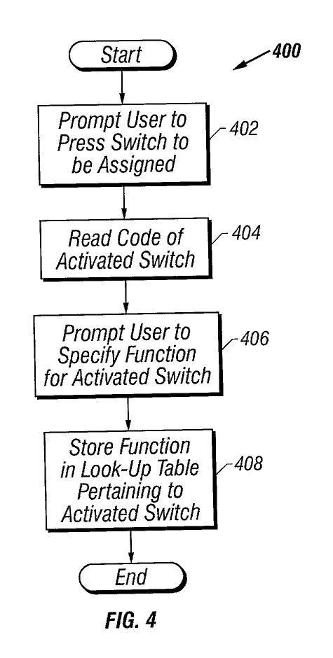

FIG. 4 illustrates a flowchart of an exemplary software program 400 preferably residing in the remote computer, network or other digital device that can be used to pre-assign functions to the keys 320 of the computer-interactive binder 300. The program 400 begins by performing the step 402 of prompting the user to press the switch (SW) on the computer-interactive binder 300 that he/she wishes to assign a function to be performed by the computer, network or digital device. After the user activates the desired switch (SW), the program 400 performs the step 404 of reading the code assigned to the activated switch that is sent from the computer-interactive binder 300 to the remote computer, network or other digital device. The program 400 then performs the step 406 of prompting the user to specify the function assigned to the activated switch. The user specifies the desired function through the use of the remote computer, network, or other digital device. Then, the program 400 performs the step 408 of storing the function in a look-up table corresponding to the activated code. If the look-up table is present in the remote computer, network or other digital device, the function is merely stored in the look-up table memory. However, if the look-up table resides in the computer-interactive binder 300, then the program downloads the function command to the computer-interactive binder 300. After step 408 is complete, the activated switch (SW) has now been assigned a function which can be performed by subsequent activation of the corresponding switch (SW). The programming of the pre-assigned functions can also be performed by a manufacturer or distributor of the binder.

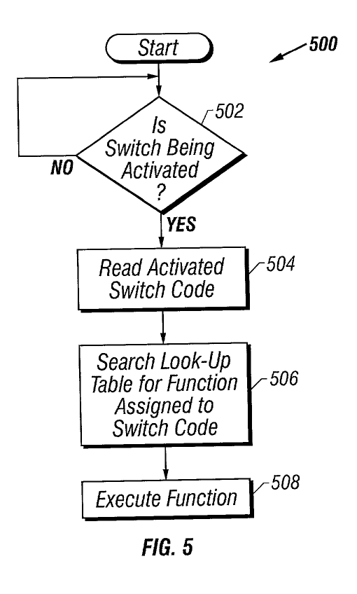

FIG. 5 illustrates a flowchart of an exemplary software program 500 residing in the remote computer, network or other digital device that can execute a function assigned to an activated switch on the computer-interactive binder 300. The program 500 begins by performing the step 502 of determining whether a switch is being activated. If no switch has been activated, the program 500 continues to monitor whether a switch is being activated. When a switch is activated, the program 500 performs the step 504 of reading the activated switch code communicated from the computer-interactive binder 300 to the remote computer, network or other digital device. The program 500 then performs the step 506 of searching the look-up table to find the function corresponding to the activated switch code. Once this is done, the program 500 performs the step 508 of executing or causing the execution of the function. If the microprocessor instead sends the function command rather than the code and the program reads the function command in step 504, the program then proceeds to execute the function.

Although software programs 400 and 500 have been described with reference to computer-interactive binder 300, it shall be understood that they can apply to all variations of computer-interactive binders and other devices described herein. In the case of a computer-interactive binder that uses radio frequency identification (RFID) tags, the reference to switch in the discussion of the programs 400 and 500 pertains to the RFID tags. In the case of a computer-interactive binder that uses force sensitive resistors (FSR), the reference to switch in the discussion of the programs 400 and 500 pertains to the activated region on the FSR pad.

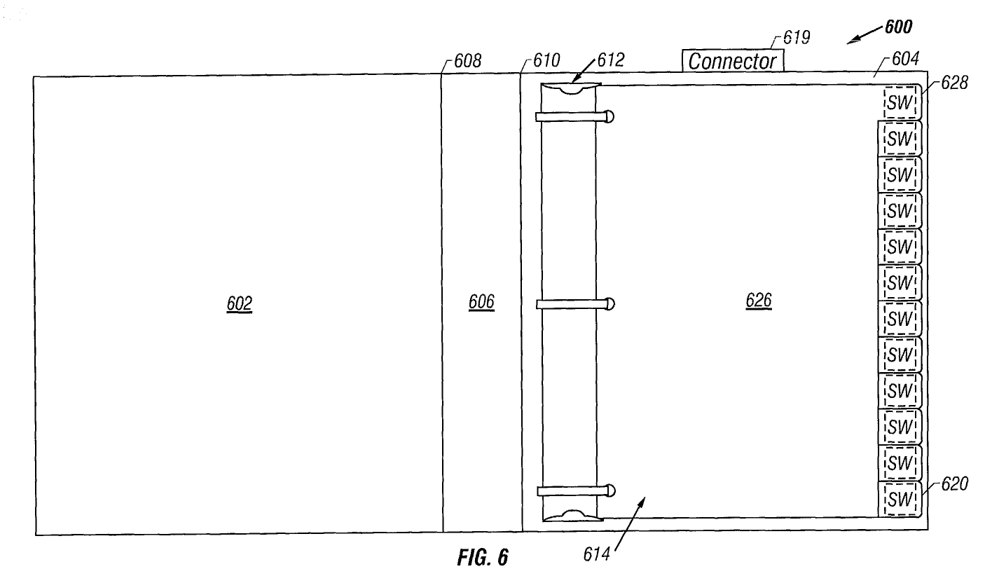

FIG. 6 illustrates an exemplary computer-interactive binder 600 of the same type as binder 300 previously disclosed. Accordingly, the reference numbers used in FIG. 6 to identify the same elements in FIG. 3 are the same, except that the most significant digit is a “6” rather than a “3.” The computer-interactive binder 600 further includes, for example, a plurality of dividers 626 bound to the binder mechanism 612. The dividers 626 include respective tabs 628 positioned over respective switches (SW). Thus, in this arrangement, any switch on the keyboard 620 pertains to a corresponding divider 626. As customary, each divider 626 can be used to categorize physical documents that include information pertaining to particular subject matters. When one of the divider tabs 628 is pressed, the corresponding switch is activated which causes the computer-interactive binder 600 to communicate with the remote computer, network or other digital device. The remote computer, network or other digital device, in turn, executes the function assigned to the activated switch. One such function, for example, is to display on a display screen supplemental information relating the subject matter that the corresponding divider 626 categorizes. Again, the applications are too numerous to mention, and are limited by the creativity of the user.

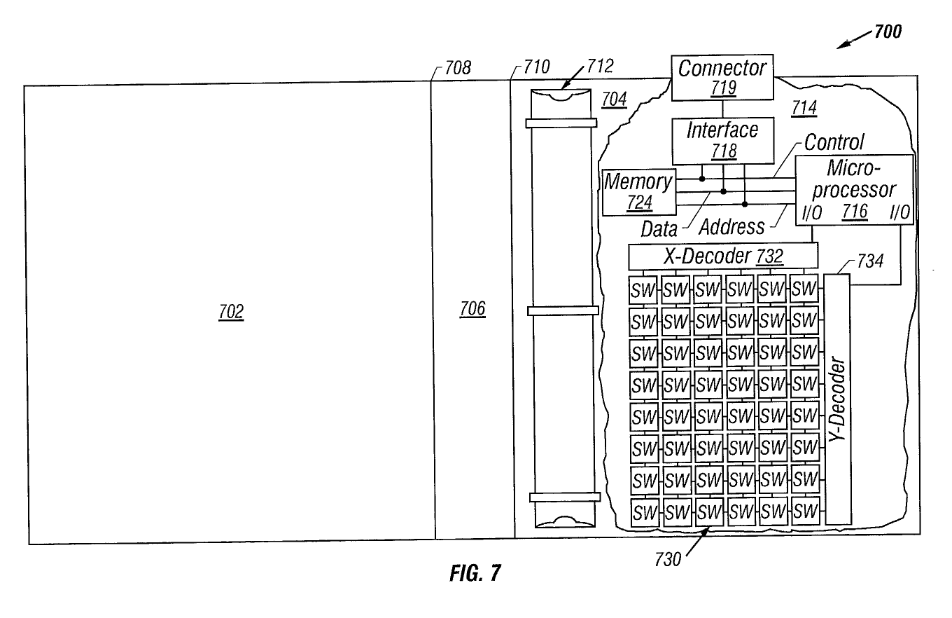

FIG. 7 illustrates an exemplary computer-interactive binder 700 of a similar type as binder 300 previously disclosed. Accordingly, the reference numbers used in FIG. 7 to identify the same elements in FIG. 3 are the same, except that the most significant digit is a “7” rather than a “3.” The computer-interactive binder 700 differs from binder 300 in that the former includes a keyboard 730 comprising a two-dimensional array of switches, instead of a one-dimensional array of switches 320. The two-dimensional array of switches 730 may be directly coupled to the microprocessor 716 or through x- and y-decoders 732 and 734. As previously described, when one of the switches (SW) is activated, the microprocessor 716 determines which switch in the keyboard 730 has been activated and generates a code that uniquely identifies the activated switch. The code could be communicated to the remote computer, network or digital device for the execution of a pre-assigned corresponding function. Alternatively, the microprocessor 716 can use the code to identify a corresponding function command in a look-up table stored in memory 724, and then communicate the command to the remote computer, network or other digital device for execution of the function.

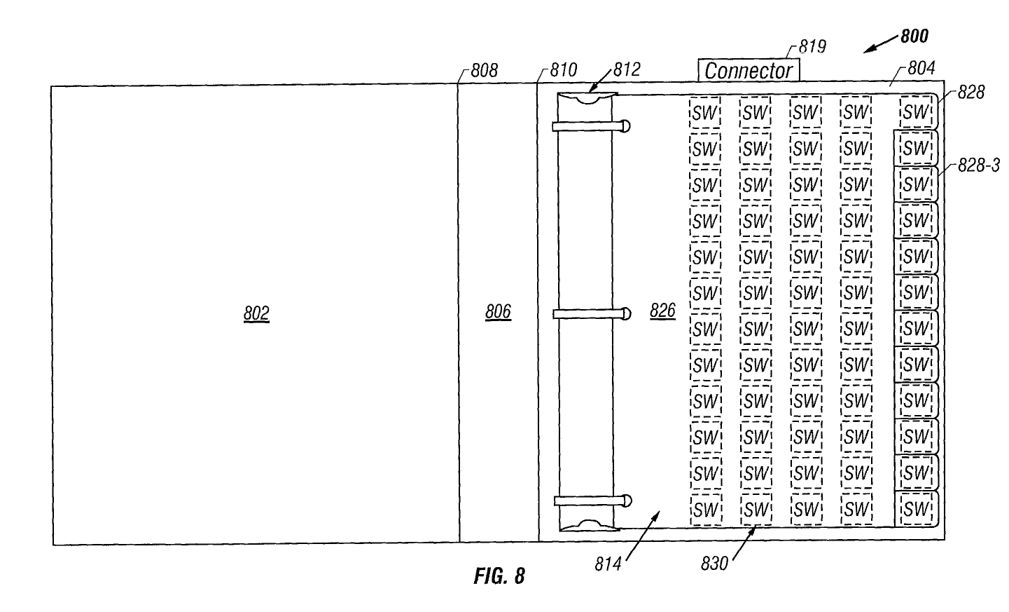

FIG. 8 illustrates an exemplary computer-interactive binder 800 of the same type as binder 700 previously disclosed. Accordingly, the reference numbers used in FIG. 8 to identify the same elements in FIG. 7 are the same, except that the most significant digit is an “8” rather than a “7.” The computer-interactive binder 800 further includes, for example, a plurality of dividers 826 bound to the binder mechanism 812. The dividers 826 include respective tabs 828 positioned over the column of switches (SW) that are closest to the right transverse edge of the back cover 804. Thus, in this arrangement, each switch (SW) on the single-line of switches at the right edge of the back cover 804 pertains to a corresponding divider 826. The remaining switches in the array 830 may be used to correlate with overlying positions on a physical documents categorized by the activated divider 828. Using this configuration, two switches need to be activated for a function to be executed by the remote computer, network or other digital device.

As an example, assume computer-interactive binder 800 is configured into an international cookbook. In this case, the dividers 826 may categorize physical documents into cuisines of different international regions. For instance, the third divider from the top having tab 828-3 can be used to categorized information relating to Chinese dishes. The physical documents categorized by divider 826-3 may list titles of various dishes overlying respective positions of switches (SW) not in the right-most column. A user can then cause the remote computer, network or other digital device to display the recipe pertaining to a selected Chinese dish by first pressing tab 828-3 to activate the underlying switch (SW). This action tells the system that Chinese dishes is the category selected. Then, the user presses the selected title and activates the underlying switch to cause the remote computer, network or other digital device to display the corresponding recipe. In this case, two switches need to be activated before the remote computer, network or other digital device executes the assigned function. The microprocessor 816 can communicate the codes of the activated switches separately or together to the remote computer, network or digital device. Alternatively, the microprocessor 816 can locate a corresponding command stored in memory 824 corresponding to the combination of the two codes.

The above is just one example of an application for a computer-interactive binder 800 having a two-dimensional array of switches. There are many other ways to use a two-dimensional array of switches to cause the execution of pre-assigned functions on a remote computer, network or other digital device.

III. Computer-Interactive Binder Using Force Sensitive Resistor Technology

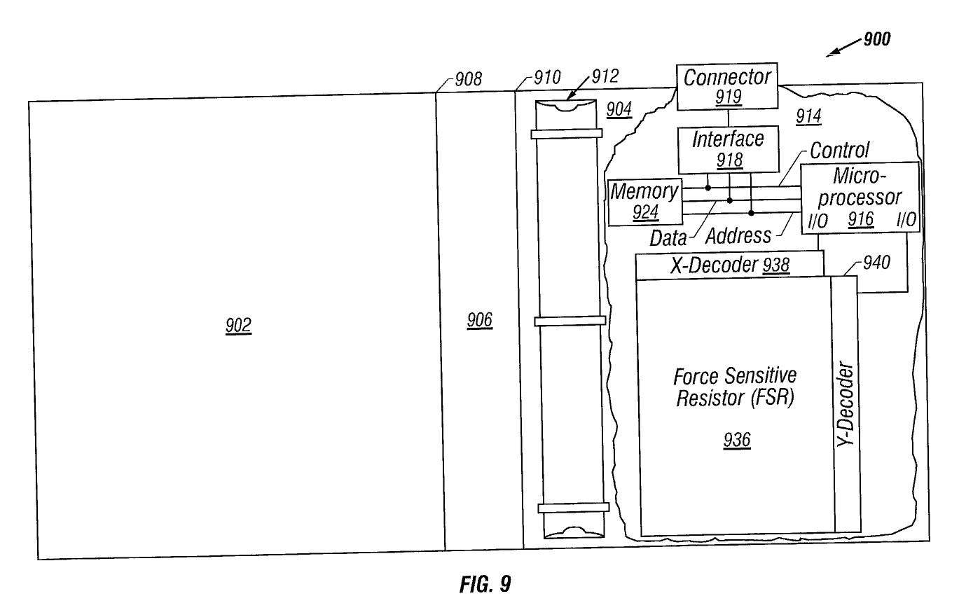

FIG. 9 illustrates an exemplary computer-interactive binder 900 having as an input device a force sensitive resistor (FSR) pad 936. As with the other binders, the same elements are identified with the same reference numbers, except that the most significant digit is a “9.” The FSR 936 and accompanying circuitry may be incorporated into any part of the binder 900, including the front cover 902, the spine 906, the binding mechanism 912, and/or the back cover 904 as shown in FIG. 9. The FSR 936 is provided with an x-decoder 938 and a y-decoder 940. When a user presses a particular region of the FSR 936, the x-decoder 938 can determine the location in the x-axis direction of the selected region, and the y-decoder 948 can determine the location in the y-axis direction of the selected region, both by sensing where a change in the resistances occurred.

The x- and y-locations of the selected region is sent to the microprocessor 916. The microprocessor 916 assigns a unique code depending on the ranges that the x- and y-locations are within. The code can then be communicated to the remote computer, network or other digital device for programming of the corresponding function or for execution of the corresponding function as previously discussed. Alternatively, the code can be used by the microprocessor 916 to search a look up table in memory 924 and locate a corresponding command to be communicated to the remote computer, network or other digital device for execution.

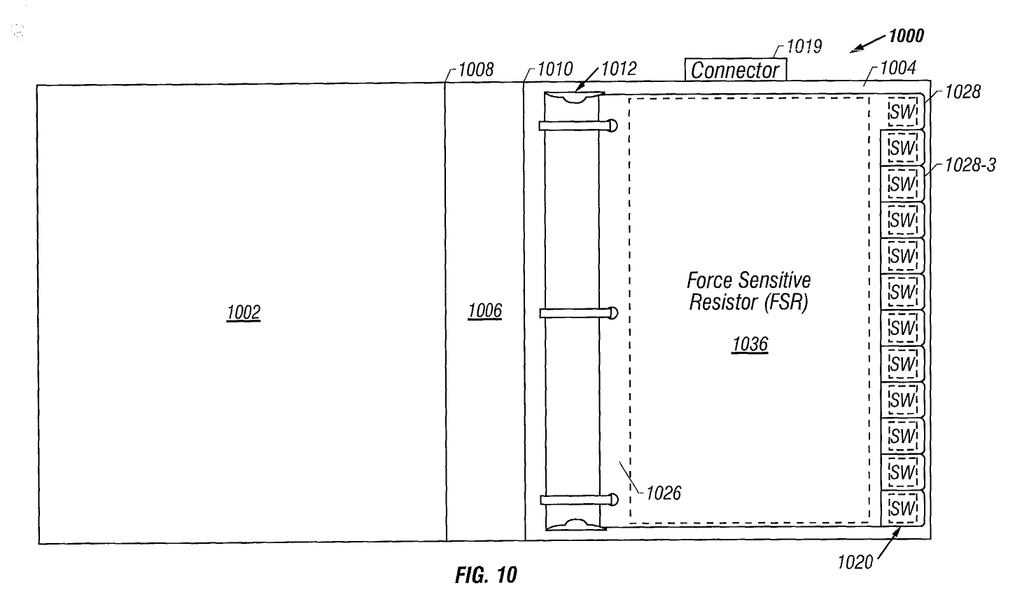

FIG. 10 illustrates an exemplary computer-interactive binder 1000 of a similar type as binder 900 previously disclosed. Accordingly, the reference numbers used in FIG. 10 to identify the same elements in FIG. 9 are the same, except that the most significant digit is a “10” rather than a “9.” The exemplary computer-interactive binder 1000 is a hybrid using a one-dimensional switch array 1020 and an FSR 1036 preferably incorporated into the back cover 1004. The binder 100 further includes a plurality of dividers 1026 bound to the binder mechanism 1012. The dividers 1026 include respective tabs 1028 positioned over respective switches (SW). The dividers 1026 may be used to categorized physical documents with markings that overly particular regions of the FSR 1036. Similar to the example described above with reference to binder 800, the switches 1020 may designate respectively different subject matters (e.g., Chinese Cuisine). The various regions of the FSR 1036 may designate particular items within the selected subject matter (e.g., recipe of a particular Chinese dish). As with binder 800, a user first selects the desired subject matter by pressing the corresponding tab 1028. Then, the user presses text on the physical document pertaining to the corresponding divider to activate an underlying region of the FSR 1036 to cause the remote computer, network or other digital device to perform the assigned function. It shall be understood that the amount of physical documents and/or divider positioned above the FSR pad 1036 may affect its ability to sense the pressing of the document by the user.

IV. Computer-Interactive Binder Using Radio Frequency Identification (RFID) Tags

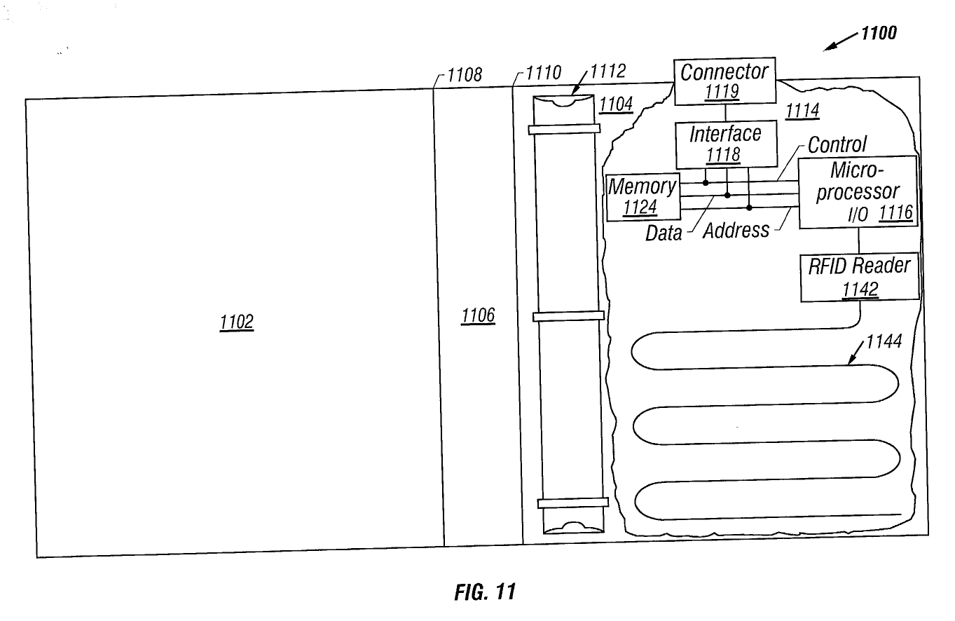

FIG. 11 illustrates an exemplary computer-interactive binder 1100 having as an input device a radio frequency identification (RFID) reader 1142 and an attached antenna 1144. As with the other binders, the same elements are identified with the same reference numbers, except that the most significant digit is an “11.” The RFID reader 1142 and antenna 1144 may be incorporated within any part of the binder 1100, including the front cover 1102, the spine 1106, the binding mechanism 1112, or the back cover 1104 as shown in FIG. 11. The RFID reader 1142 and antenna 1144 are used in conjunction with RFID tags (not shown in FIG. 11) that may be placed on the binder, binder inserts or bound physical documents. The RFID reader 1142 and antenna 1144 emit an RF electromagnetic field. When an RFID tag is activated by a user, the RFID tag interacts with the electromagnetic field in a manner that the RFID reader can detect a unique code for the activated RFID tag. As with all the other embodiments of the computer-interactive binders, the microprocessor 1116 can communicate the code to the remote computer, network or other digital device for either programming of the corresponding function or for execution of the corresponding function as previously discussed. Alternatively, the code can be used by the microprocessor 1116 to search a look up table in memory 1124 and locate a corresponding command to be communicated to the remote computer, network or other digital device for execution.

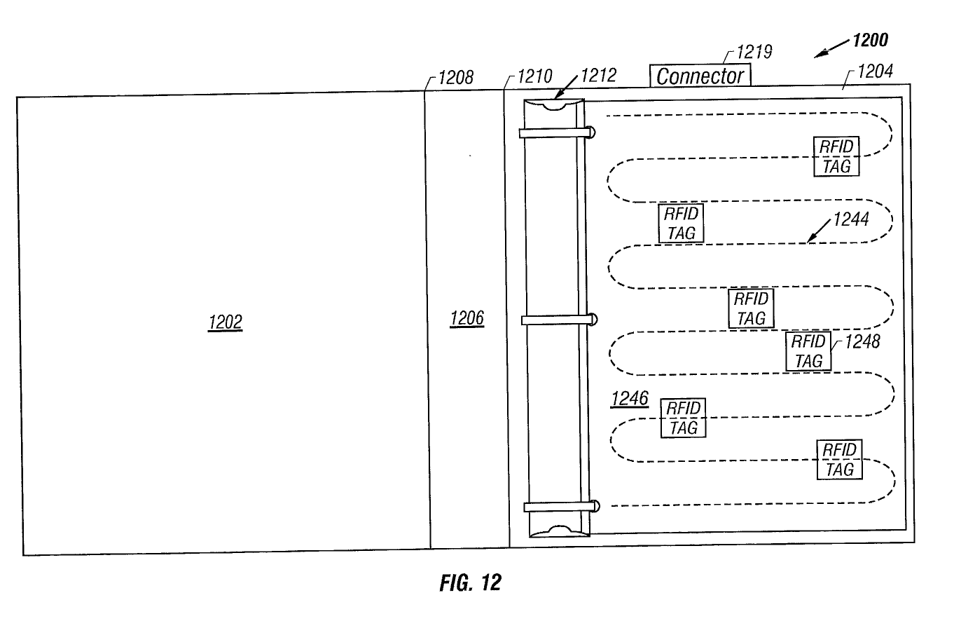

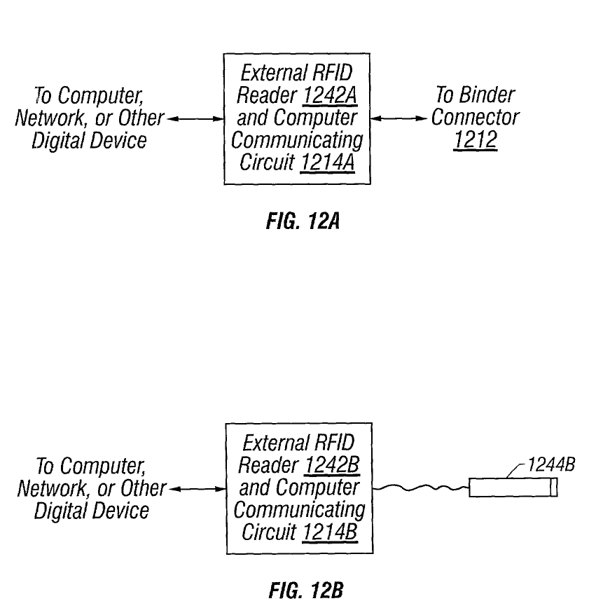

FIG. 12 illustrates an exemplary computer-interactive binder 1200 of a similar type as binder 1110 including an internal RFID reader 1242 coupled to a computer communicating circuit 1214 (not shown in FIG. 12). Accordingly, the reference numbers used in FIG. 12 to identify the same elements in FIG. 11 are the same, except that the most significant digits is a “12” rather than a “11.” The binder 1200 includes a physical document 1246 bounded to the binder mechanism 1212. A plurality of RFID tags 1248 are placed by the user on the document 1246 preferably to correlate with some text or other printed matter on the document. Each RFID tag 1248 may have an adhesive to securely attach them to the document 1246. A batch of RFID tags 1248 may be purchased with the computer-interactive binder 1200 or may be purchased separately. Each RFID tag has a unique code associated with it. When a user activates an RFID tag 1248, the RFID reader 1242 reads the unique code of the activated RFID tag and communicates it to the microprocessor 1216. In the programming mode, the code is used to assign a function to the activated RFID tag as previously discussed. In the executing mode, the code is used to cause the remote computer, network or other digital device to execute a pre-assigned function as previously discussed. The advantage with the RFID tags is that they can be placed anywhere on the document, and therefore may be placed by the user on a printed document adjacent hard copy information which the user wishes to link to electronic information.

Link devices in the form of user-applied, variable location tags or labels offer the advantage that the link to a physical document or object is independent from the placement of the document or object within the binder. Instead, the link is associated with the chosen document, or perhaps with a given portion of or location within the document. It is possible as well to provide repositionable links, as for example RFID tags with removable pressure sensitive adhesive.

The RFID reader 1242 and the computer-communicating circuit 1214 need not be located physically on the binder or an insert, but may be located as an external unit electronically coupled to the binder or insert. FIG. 12A illustrates a block diagram of an external RFID reader 1242A/computer-communicating circuit 1214A. The external unit is coupled to the connector 1212 of the computer-interactive binder 1200 and coupled to the remote computer, network or other digital device. In this case, the binder 1200 incorporates an RFID antenna 1244 that is directly coupled to the connector 1212. When a user activates one of the RFID tags 1248, it interacts with the electromagnetic field generated by the antenna 1244A to cause the external RFID reader 1242A to sense the identification code associated with the activated RFID tag 1248. The code or a command associated with the code can be communicated to the remote computer, network or other digital device through the use of the external computer-communicating circuit 1214.

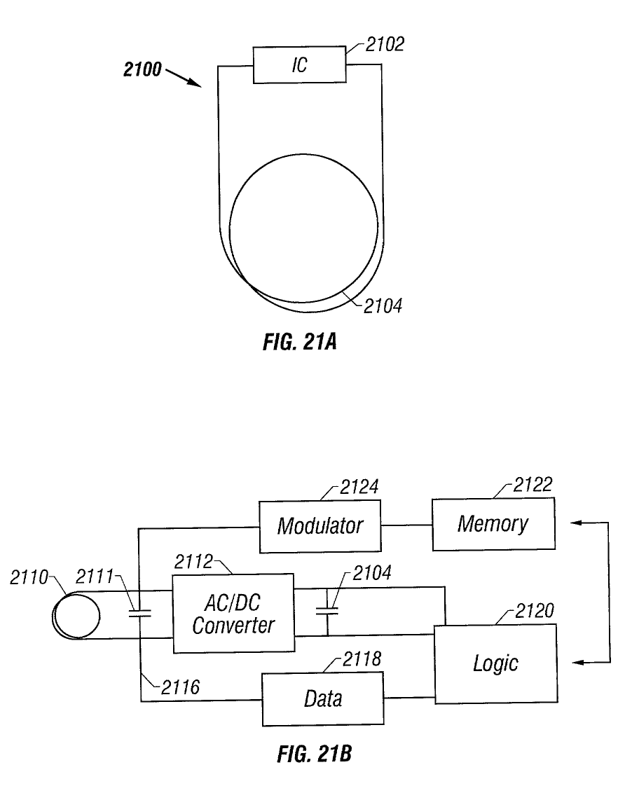

In addition, the antenna 1244 in addition to the RFID reader 1242 and the computer-communicating circuit 1214a need not be located physically on the binder or an insert, but may be located as an external unit electronically coupled to the binder or insert. FIG. 12B illustrates a block diagram of an external RFID reader 1242B/computer-communicating circuit 1214B and RFID wand 1244B that functions as an external RFID antenna. The external unit is coupled to the remote computer, network or other digital device. In this case, when a user desires to activate a particular RFID tags 1248, the user positions the RFID wand 1244B in proximity to the desired RFID tags. The type of RFID tag used with an external RFID reader having a wand is the conventional type RFID shown in FIG. 21A. The electromagnetic field generated by the RFID wand 1244B causes the external RFID reader 1242B to sense the identification code associated with the desired RFID tag 1248. The code or a command associated with the code can be communicated to the remote computer, network or other digital device through the use of the external computer-communicating circuit 1214.

V. Computer-Interactive Pad Using Radio Frequency Identification (RFID) Tags

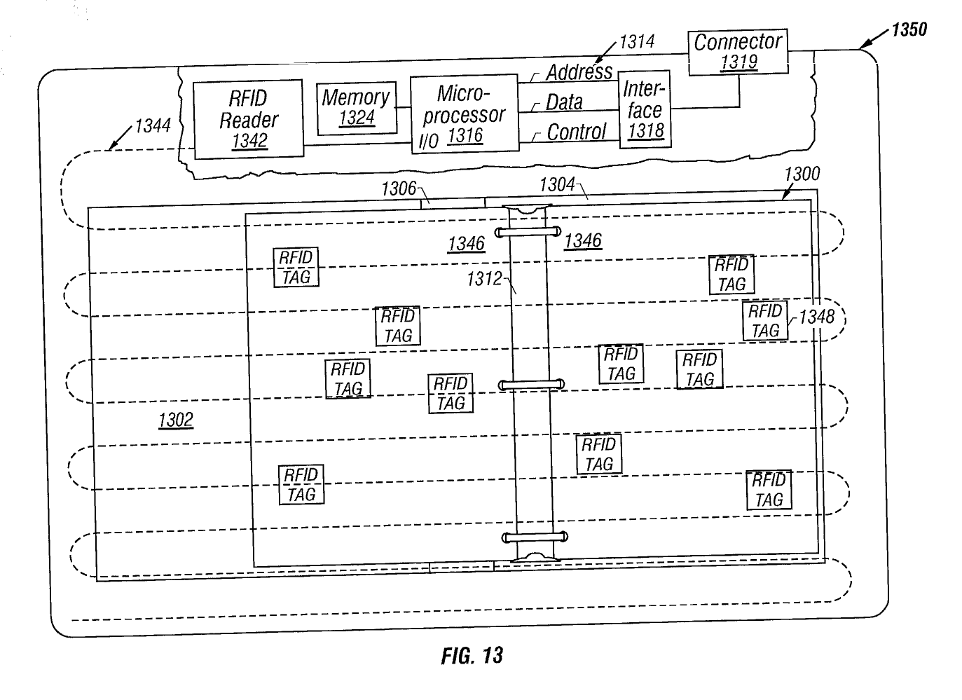

FIG. 13 illustrates an exemplary computer-interactive pad 1350 that has an RFID reader 1342 and antenna 1342 incorporated into the pad. The computer-interactive pad 1350 further includes a computer communicating circuit 1314 coupled to the RFID reader 1342 for communicating with a remote computer, network or other digital device. The computer-interactive pad 1350 operates in the same manner as computer-interactive binders 1100 and 1200. In the example shown in FIG. 13, a binder 1300 is placed on the computer-interactive pad 1350. The binder 1300 may have physical documents with RFID tags 1348 thereon. Activation of an RFID tag 1348 causes the RFID reader 1342 to read a unique code assigned to the activated tag which can be used by the microprocessor 1316 to either assign a function to the activated RFID tag 1348 as previously discussed, or cause the execution of the assigned function by a remote computer, network or digital device as previously discussed. The reference numbers used in FIG. 13 to identify the same elements in the other embodiments described herein are the same, except that the most significant digits is a “13” The RFID reader 1342 and the computer-communicating circuit 1314 may be located external to the pad as previously discussed with reference to FIGS. 12A and 12B.

VI. Computer-Interactive Binder Inserts or Sheet Protectors Using Switch Technology

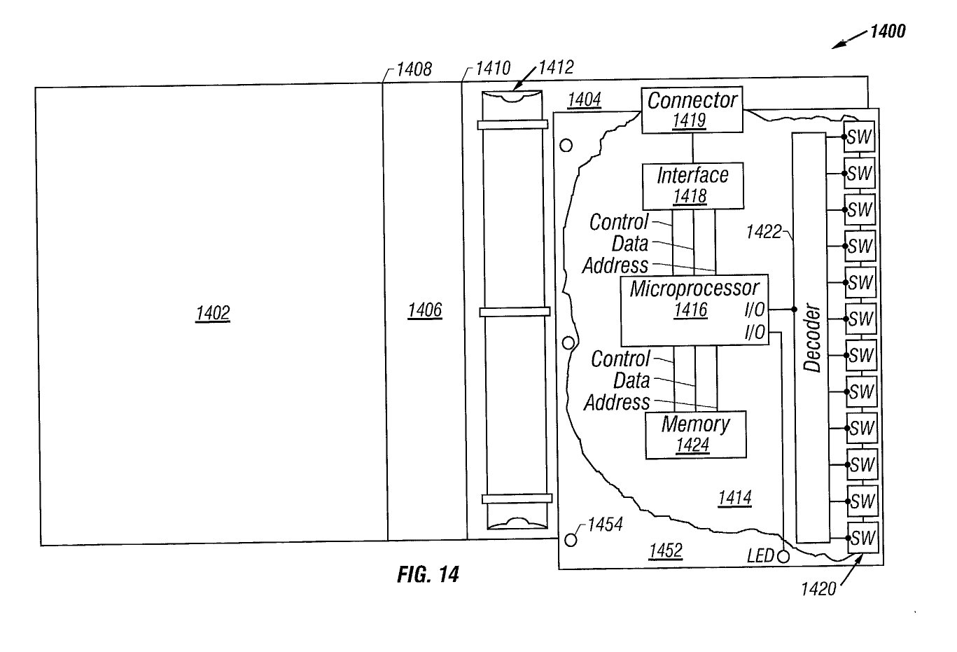

FIG. 14 illustrates a computer-interactive binder insert (or sheet protector) 1452 that can be bounded to a notebook binder 1400. The reference numbers used in FIG. 14 to identify the same elements in other embodiments described herein are the same, except that the most significant digits is a “14.” The computer-interactive binder insert 1452 may include one or more perforated holes 1454 for binding to the binder mechanism 1412 of the notebook binder 1400. The computer-interactive binder insert 1452 incorporates a computer communicating circuit 1414 and keyboard 1420 for communicating with a remote computer, network or other digital device as previously discussed. Although the keyboard 1420 is shown in FIG. 14 to be a one-dimensional array of switches, it shall be understood that the computer-interactive insert 1452 can also incorporate a two-dimensional array of switches, an FSR pad, or RFID reader and antenna as previously discussed.

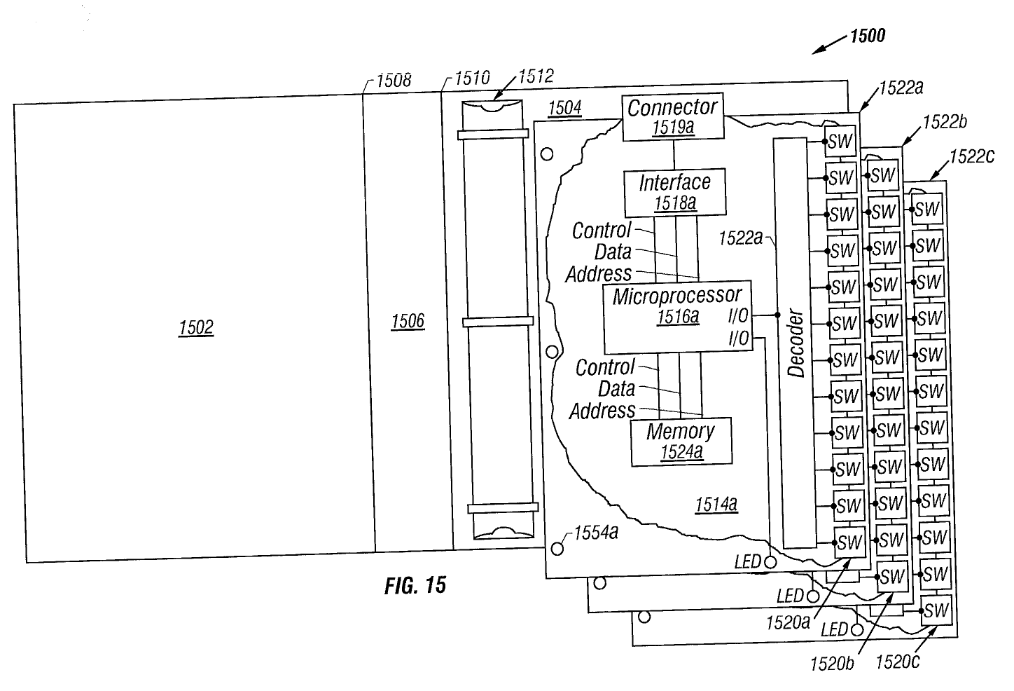

FIG. 15 illustrates a plurality of computer-interactive binder inserts 1552a-c that can be bounded within notebook binder 1500 in a stacked manner. The reference numbers used in FIG. 15 to identify the same elements in other embodiments described herein are the same, except that the most significant digits is a “15.” The computer-integrated binder inserts 1552a-c have respective computer communicating circuits 1514a-c and respective keyboards 1520a-c for communicating with a remote computer, network or digital device as previously discussed. Because there are multiple computer-interactive inserts 1552a-c, it is preferred that the computer communicating circuit 1514a-c generates respective codes that uniquely identifies the inserts 1554a-c. Although the keyboard 1520a-c are shown in FIG. 15 to be a one-dimensional array of switches, it shall be understood that the computer-interactive inserts 1552a-c can also respectively incorporate two-dimensional array of switches, FSR pads, RFID readers/antennas as previously discussed. In addition, the computer-interactive inserts 1552a-c need not all have the same type of keyboards, but one can be, for example, of the switch type, another can be of the FSR type, and yet the other can be of the RFID type.

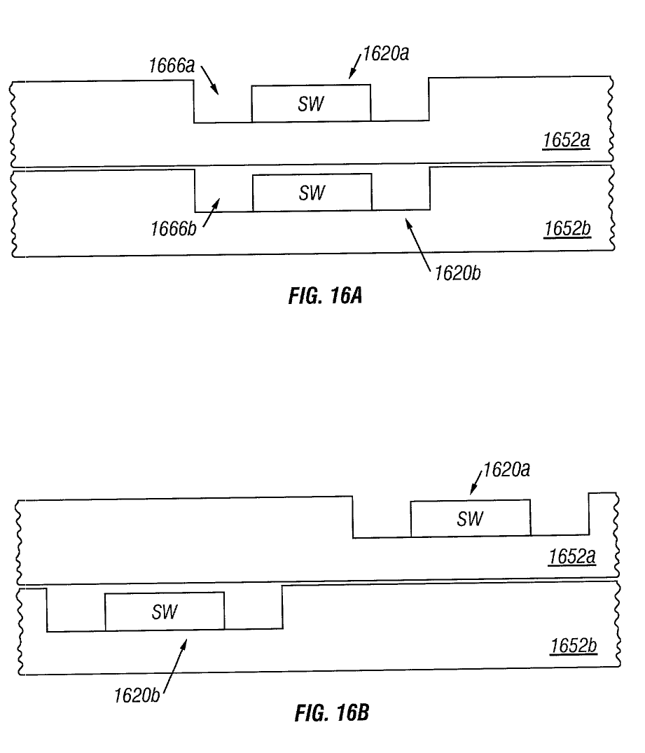

FIGS. 16A and 16B illustrate portions of computer-interactive binder inserts 1652a and 1652b that are stacked within a notebook binder. The computer-interactive inserts 1652a and 1652b include switch-type of keyboards 1620a and 1620b . In the case of FIG. 16A, the computer-interactive inserts 1652a and 1652b are configured the same, and therefore, the push button switch 1620a lies directly above the push-button switch 1620b. So as to prevent the underlying push-button switch 1620b from being activated when a user presses the overlying push-button switch 1620a, the switches 1620a and 1620b are formed within respective recesses 1666a and 1666b. The top of the underlying insert 1652b prevents the bottom of the overlying insert 1652a from contacting the underlying push-button switch 1620b. However, the switches 1666a and 1666b need not be vertically stacked, but can also be vertically offset from each other as shown in FIG. 16B to better prevent the activation of the underlying switch 1620b when a user presses the overlying push-button switch 1620a. The switch configurations of FIGS. 16A and 16B can also be applied to RFID tags.

VII. Computer-Interactive Binder with Interlocking Member

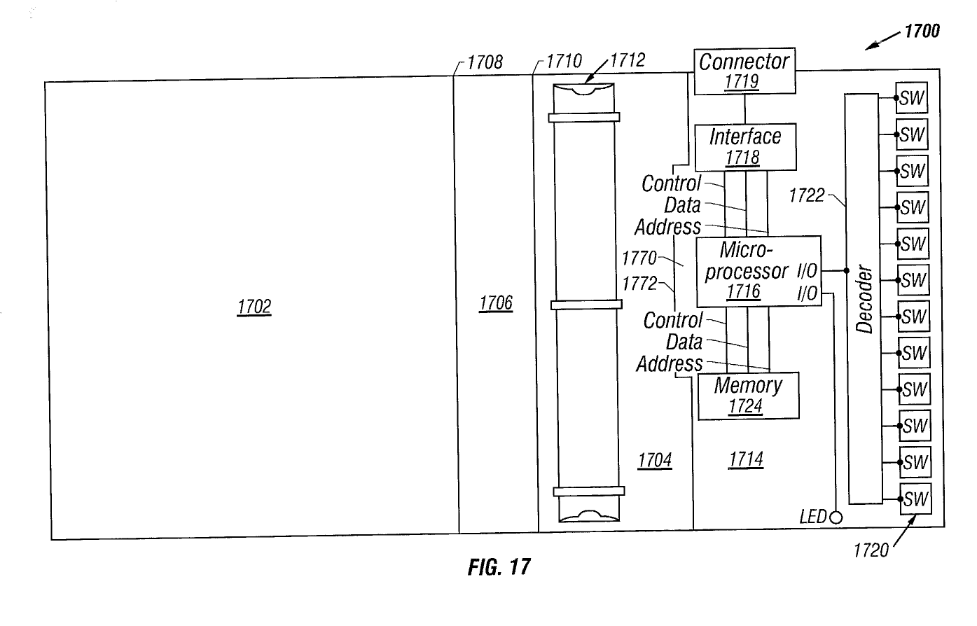

FIG. 17 illustrates a binder 1700 that has a computer-interactive interlocking member 1768 that incorporates the computer communicating circuit 1714 and keyboard 1720 for communicating with a remote computer, network or digital device. The reference numbers used in FIG. 17 to identify the same elements in other embodiments described herein are the same, except that the most significant digits is a “17.” The computer-interactive interlocking member 1768 includes a mechanical connector symbolically represented as 1770 that securely mates with a corresponding mechanical connector symbolically represented as 1772 on the back cover 1704 of the binder 1700. In this way, the computer-interactive interlocking member 1768 can be detached from the binder 1700 so that the binder is used in its normal manner. Then, when the user desires to interface the binder 1700 with a computer, network or other digital device, the computer-interactive locking member 1768 is attached to the binder 1700, thereby giving it computer-communicating capability.

Although the computer-interactive interlocking member 1768 is shown connected to the back cover 1704, it shall be understood that the interlocking member 1768 can be attached to other parts of the binder 1700, including the front cover 1702. Further, even though the keyboard 1720 is shown in FIG. 17 to be a one-dimensional array of switches, it shall be understood that the computer-interactive interlocking member 1768 can also incorporate a two-dimensional array of switches, an FSR pad, or RFID reader/antenna as previously discussed.

VIII. Preferred Physical Assemblies for the Computer-Interactive Binder and Insert

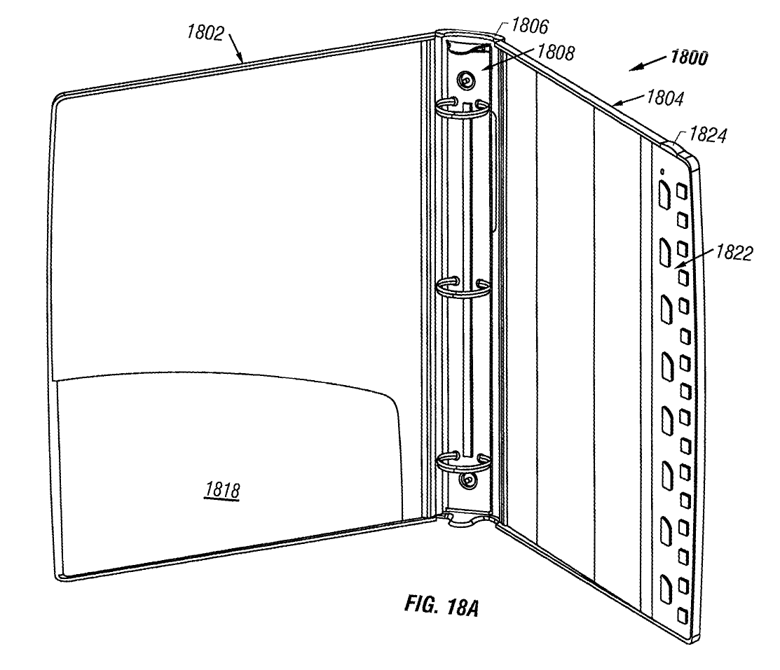

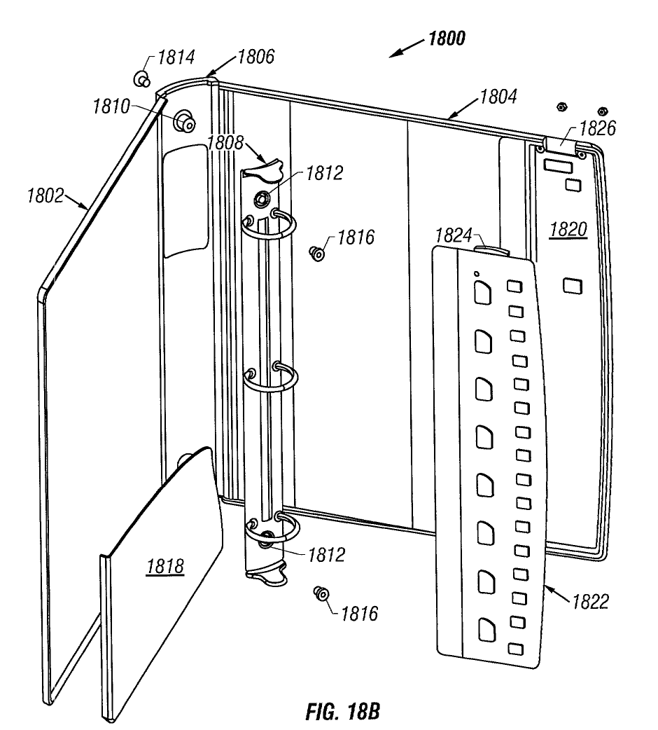

FIGS. 18A and 18B illustrate perspective and broken views of the preferred assembly of a computer-interactive binder 1800 in accordance with the invention. The computer-interactive binder 1800 comprises a front cover 1802, a back cover 1804, both of which are pivotably joined to respective opposite sides of a spine 1806. The computer-interactive binder 1800 further includes a three-ring binder mechanism 1808 that is securely attached to the spine 1806 by a pair of connectors 1810 on the spine 1810 that insert into respective holes 1812 on the binder mechanism 1808 and are secured by respective screws 1814 and nuts 1816. The inside of the front cover 1802 may have a pocket 1818. The back cover 1804 includes a recess 1820 for housing a PC board having a computer-communicating circuit (not shown in FIGS. 18A and 18B) and receiving keyboard 1822. The keyboard 1822 is attached to the back cover 1804 by clip connector 1824 and corresponding slot 1826.

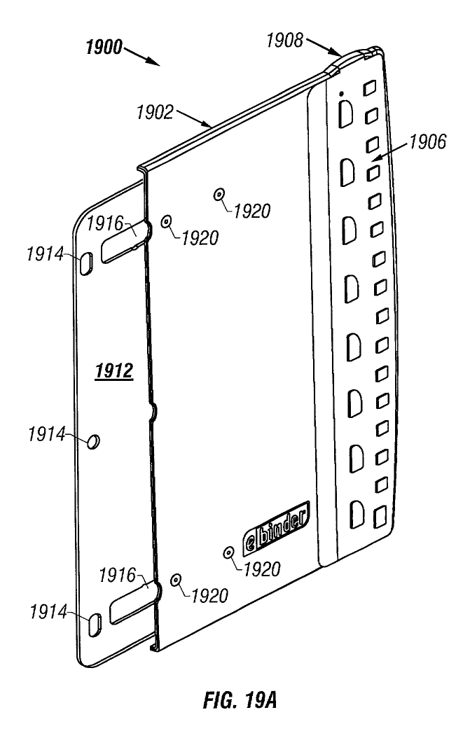

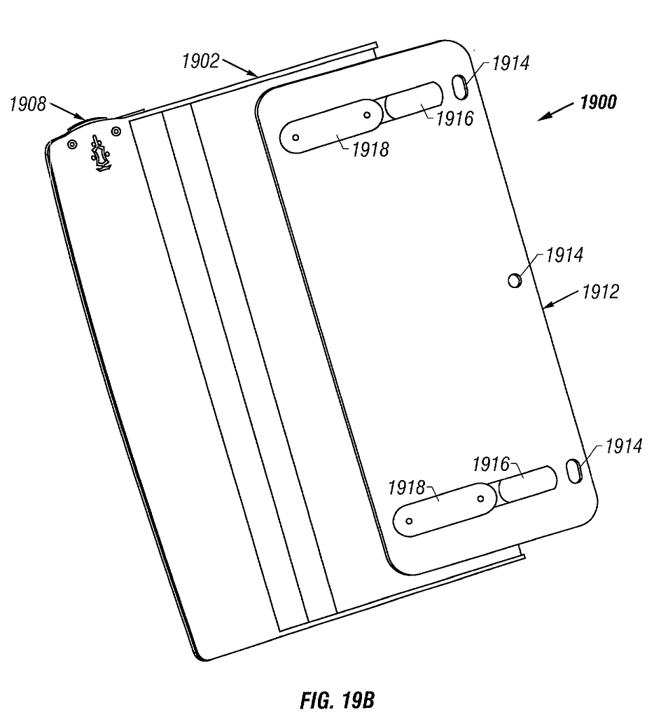

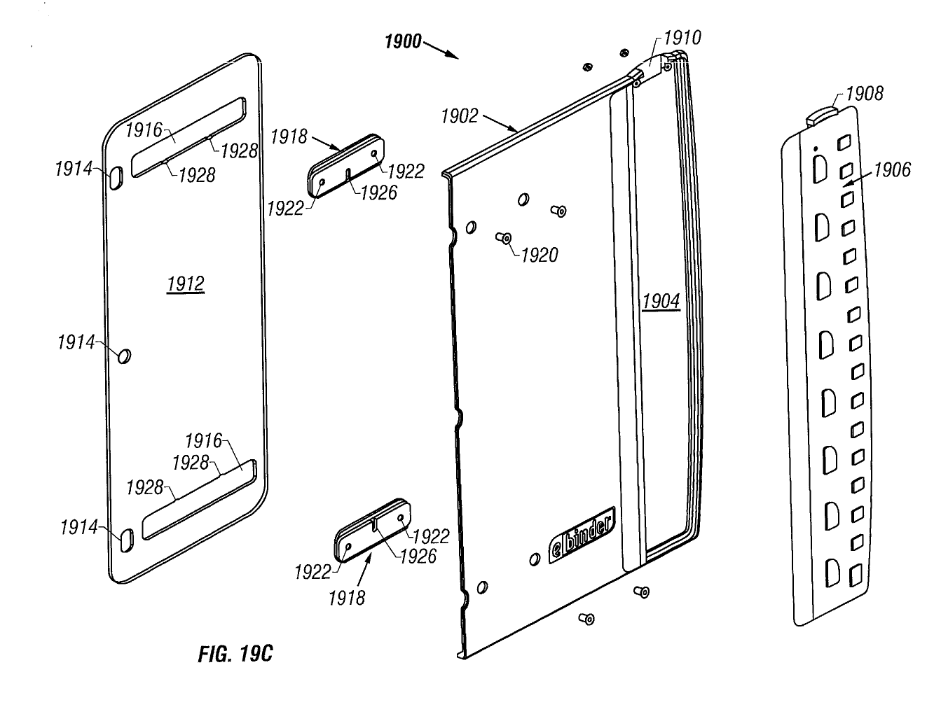

FIGS. 19A-19C illustrate front perspective, back perspective and front broken views of the preferred assembly of a computer-interactive binder insert 1900 in accordance with the invention. The computer-interactive binder insert 1900 comprises a panel 1902 having a recess 1904 for housing a PC board having a computer-communicating circuit (not shown in FIGS. 19A-19C) and receiving keyboard 1906. The keyboard 1906 is attached to the panel 1902 by clip connector 1908 and corresponding slot 1910. The computer-interactive binder insert 1900 further includes an adjustable extender 1912 having openings 1914 for insertion within binder rings (not shown in FIGS. 19A-19C). The adjustable extender 1912 also includes a pair of transverse slots 1916 configured to receive respective sliders 1918. The sliders 1918 are securely attached to the back side of panel 1902 by threaded screws 1920 that mate with respective threaded holes 1922 on sliders 1918 through respective holes 1924 of panel 1902. The sliders 1918 also include respective protrusions 1926 that are configured to mate with grooves 1928 on the boundary of the slots 1916. There are preferably two grooves 1928 per each slot to give the extender 1912 two adjustable positions.

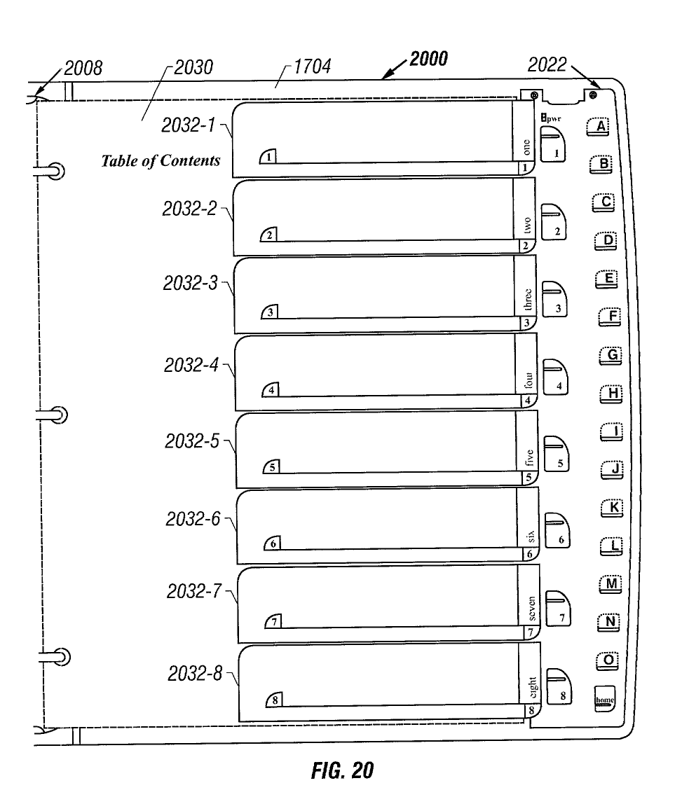

FIG. 20 illustrates an exemplary computer-interactive binder 2000 of the same type as binder 1800 shown in FIG. 18. Accordingly, the reference numbers used in FIG. 20 to identify the same elements in FIG. 18 will be the same, except that the most significant digits is a “20” rather than an “18.” The computer-interactive binder 2000 comprises a keyboard 2022 having two sets of color-coded, push-button switches 1-8 and A-O. The switches 1-8 can be used to select distinct subject matters. The switches 1-8 may be used with a table of content binder insert 2030. The table of content insert 2039 includes subject matter identification regions 2032-1 through 2032-8 which allows a user to identify the subject matters pertaining to the various switches 1-8. The identification regions 2032-1 through 2032-8 is preferably color-coded with the respective switches 1-8 and preferably aligned therewith.

The switches A-O can be used to correlate with a specific information item within a selected subject matter 1-8. The computer-interactive binder 2000 requires the activation of two keys in order for the remote computer, network or other digital device to execute the pre-assigned function. For example, the user can first select one of switches 1-8 to designate the subject matter of interest, then the user selects one of switches A-X to cause the remote computer, network or digital device to execute the desired pre-assigned function. The keyboard 2020 may also include a home button to cause the software program to return to a main menu for prompting the user to either assign a new function to the keys, to execute another pre-assigned function, or for any other purposes.

IX. Other Types of Binders and Stationary Products

As it was previously discussed, there are many types of binders and stationary products that may incorporate the computer-interactive technology of the invention as discussed above. Notebook binders, inserts, pads and sheet protectors have already been discussed. The computer-interactive binder of the invention also includes organizers, calendars/day planner and other similar products. In addition, the computer-interactive technology of the invention can be incorporated into other types of binders, including those disclosed in U.S. Pat. Nos. 4,583,877,entitled “Ring Binder Cover”; 4,600,346 entitled “Binder Cover and Method of Manufacture Thereof”; 4,629,349 entitled “Flexible Transparent Notebook And The Like”; 5,028,159 entitled “Looseleaf Binder”; 5,620,207 entitled “Ring Binder Cover”; 5,857,797 entitled “Loose Leaf Binder Including An Exterior Picture Frame”; and 5,911,441 entitled “Zippered Three-Ring Binder Carrying Case With Additional External Zippered Cover For Notepad.” The entire disclosure of each of these patents is incorporated herein by reference.

Thus, as discussed in the above patents which are incorporated by reference, the binder may hold or contain physical documents, such as pieces of paper, photographs on pages, etc. which can be bound within the binder in any number of conventional ways. In addition, the binder may contain other types of objects, such as relatively compact objects which may be contained in a pocket or similar compact storage compartment in the binder; as well as bulkier objects which may be contained in more voluminous storage compartments such as binderattached backpacks, accordion files, etc. The link devices of the invention may be applied to any of these types of physical documents or other objects.

X. The Preferred RFID TAG Technology

The preferred embodiments of the RFID tags used in conjunction with the digital binder embodiments and other RFID embodiments are described in greater detail in co-pending patent application Ser. No. 09/306,688, filed on May 6, 1999 and entitled “Interactive Radio Frequency Tags, ” the entire disclosure of which is incorporated herein by reference.

FIG. 21 A illustrates a conventional passive RF tag that can be used with the RFID binders and other RFID embodiments described herein. The tag 2100 has two main components: a semiconductor chip [integrated circuit (IC)] 2102 having interface circuits, logic, and memory (not shown); and an antenna 2104. The interface circuits of the IC 2102 portion of a passive RF tag typically include an analog and a digital circuit. The analog circuit detects and decodes the RF signal and provides power to the digital circuit using the RF field strength of the reader. The digital circuit implements an information protocol which has been previously programmed into the tag.

FIG. 21B depicts a block diagram providing additional structural information for a typical passive RF tag. The figure is not a schematic depiction of an RF tag, but is intended as an illustration of the main function elements of a typical tag and their interconnections to provide a basis for describing the actions that take place when a tag (transponder) enters the RF field of a reader (transceiver), in order to assist in the understanding of the operation of RF tags.

An RF signal from a transceiver is received by the tag's antenna 2110 when the tag enters the reader's RF field. From the antenna 2110, the signal is typically smoothed by a capacitor 2111, and split into a portion that provides the power for the tag, and a portion that provides the data to be read by and responded to by the tag's programmed logic. The power portion of the signal goes into a rectifier 2112 (AC to DC converter) and the emerging DC signal is smoothed by a capacitor 2104. The data portion of the split signal is conveyed along a conductive line 2116 to a data extractor 2118 which demodulates the signal and extracts the digital binary command data for the logic processor 2120. The logic processor 2120 receives the command and carries out the command instructions, which typically involves reading data from the tag's memory 2122. The data read from the memory 2122 is then output to a modulator 2124 which modulates the digital data into an analog signal. The signal is then conveyed to the antenna 2110 and transmitted back to the transceiver. RF tags also typically include additional elements not illustrated in FIG. 21B or discussed above, such as encoders/decoders and clock extractors.

When the tag comes within a RF signal field generated by a reader (transceiver) the tag responds to the transceiver's incident RF signal alerting the transceiver of its presence. A typical reader includes a computer processor which issues commands to a RF transmitter and receives commands from an RF receiver. The processor may also perform one or more functions based on the tags presence in its RF field.

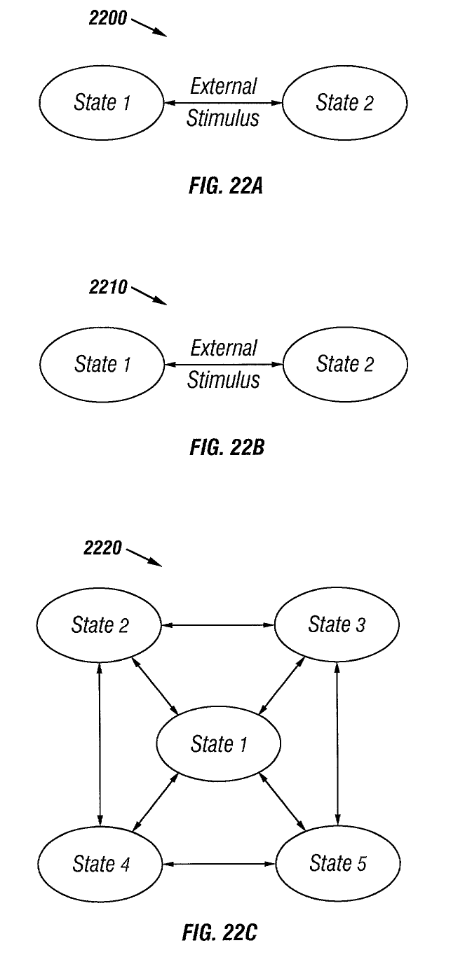

The digital binder of the present invention preferably uses interactive radio frequency transponders, frequently referred to as RF tags. These tags are responsive to external stimuli to change state. The change of state of a tag may produce a different output from the tag when it is polled upon entering the RF field of a radio frequency transceiver, frequently referred to as a RF tag reader. The change of state produced by the external stimulus may be reversible, such as in the case of many implementations of “button tags, ” wherein a change of state results when one or more buttons on the tag is pushed by a user. This situation is illustrated in FIG. 22A, which shows a state diagram 2200 in which an external stimulus (such as a user depressing a button on the tag) produces a change of state from STATE 1 to STATE 2, or vice versa, as represented by the double-headed arrow.

Alternatively, the change of state produced by the external stimulus may be irreversible, such as in the case of many implementations of “sensor tags,” wherein a change of state results when a given environmental condition is experienced by the tag (e.g., a temperature threshold is surpassed). This situation is illustrated in FIG. 22B, which shows a state diagram 2210 in which an external stimulus (such as a user depressing a button on the tag) produces a change of state from STATE 1 to STATE 2, or vice versa, as represented by the single-headed arrow.

An interactive RF tag may also be configured to have a plurality of states in which it may operate depending on a particular external stimulus received. This situation is represented by the “web” structure illustrated in FIG. 22C, which shows a state diagram 2220 in which an external stimulus (such as a user depressing a button on the tag) produces a change of state from STATE 1 to STATE 2, or vice versa. Additionally, the change of state may be from STATE 1 to any of a number of other states (e.g., STATE 3, STATE 4, or STATE 5 in the illustrated embodiment), or from one of those states to another state, as represented by the double-headed arrows, when another external stimulus (such as a user depressing a different button on the tag) is applied to the tag. This latter implementation may find particular use in applications where the interactive tag is used as a controller, and each states results in a different control command being returned to a tag reader in a device under control of the tag.

Interactive radio frequency tags preferably include a passive radio frequency transponder, having an antenna, an interface for receiving an external stimulus, and one or more integrated circuits responsive to the external stimulus received at the interface to change the state of the transponder. The nature of the interface and the corresponding external stimuli, as well as the change of state may vary substantially while remaining consistent with this inventive concept, as discussed in more detail below.

Button Tags

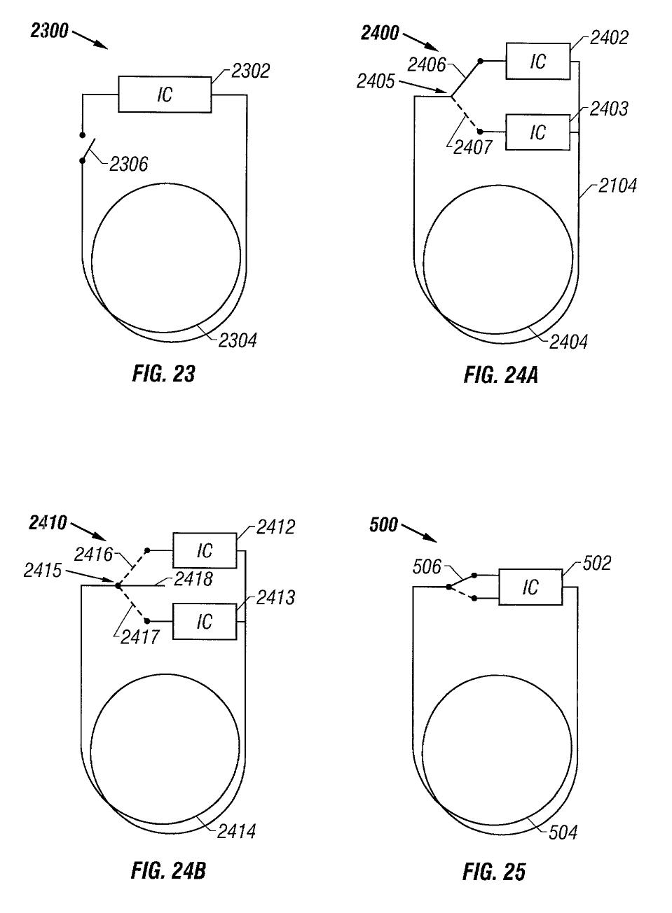

Tags may be configured to change state when a user contacts and/or manipulates an interface on the tag, for example, one or more buttons on the tag is pushed or turned by a user (“button tags”). Variations on this idea include a “single button tag” that may only be read when a button on the tag is pushed; a “switch” tag that switches between memories (or memory addresses) that are accessed for response information when the tag is polled by a reader depending on whether or not a button, or which button, is pushed; an “analog switch” tag that provides a variable response accessed from a memory based on the amount of pressure the user applies to a pressure-sensitive pad, or the movement a user applies(e.g., sliding or turning) to a motion-sensitive button on the tag. FIGS. 23 through 29 illustrate various embodiments of user contact tags that can be used with the computer interactive binder of the invention.

FIG. 23 illustrates a first embodiment of a (passive) interactive radio frequency transponder. As with a conventional RF tag, the transponder 2300 has a semiconductor chip (integrated circuit (IC)) 2302 with RF circuits, logic and memory, and an antenna 2304. In addition, this embodiment includes a switch 2306 which interrupts the signal flow from the antenna 2304 to the IC 2302. Thus, this transponder 2300 may only be read by a radio frequency transceiver when the switch 2306 is closed. Closing the switch changes the state of the transponder from unreadable to readable. In a preferred embodiment, this switch 2306 is a mechanical switch which is closed by an external stimulus when a user applies pressure to a button on the transponder.

FIG. 24A illustrates a second embodiment of an interactive radio frequency transponder. Like the transponder illustrated in FIG. 23, the transponder 2400 is also a “button tag.” This embodiment, however, has two ICs 2402 and 2403 together with an antenna 2404. The transponder 2400 also has a switch 2405 which may be in one of two positions 2406 or 2407, to connect the ICs 2402 or 2403, respectively. The switch 2405 interrupts the signal flow from the antenna 2404 to the ICs 2402 and 2403. Thus, the response provided to a polling transceiver by this transponder 2400 is determined by which position the switch is in. If the switch 2405 is position 2406, IC 2402 is activated and determines the response provided to the polling transceiver. Similarly, if the switch is in position 2407, IC 2403 is activated and determines the response provided to the polling transceiver.

FIG. 24B illustrates an alternative embodiment of the embodiment shown in FIG. 24A. Like the transponder illustrated in FIG. 24A, the transponder 2410 has a switch 2415. However, in this embodiment, the switch 2415 may be in one of three positions 2416 or 2417 to connect the ICs 2412 or 2413, respectively, or 2418 which is an open circuit position. The switch 2415 interrupts the signal flow from the antenna 2414 to the ICs 2412 and 2413. Thus, the response provided to a polling transceiver by this transponder 2410 is determined by which position the switch is in. If the switch 2415 is position 2416, IC 2412 is activated and determines the response provided to the polling transceiver. Similarly, if the switch is in position 2417, IC 2413 is activated and determines the response provided to the polling transceiver. If the switch is in position 2418, there are no closed circuits meaning that no power or data reaches either IC in the transponder, so the tag 2410 cannot be read.

A person of skill in the art will recognize that there are many possible alternative implementations of the embodiments illustrated in FIGS. 24A and 24B. For example, rather than the transponder having two separate ICs, it may instead have a single IC in which different memory addresses are accessed depending on which position a switch controlled by a user is in.

FIG. 25 illustrates another embodiment of an interactive radio frequency transponder which illustrates an example of this concept. The transponder 2500 has an IC 2502, an antenna 2504, and a single switch 2506 that closes different circuits depending on its position. In the transponder illustrated in FIG. 25, the switch has two positions, each of which results in the closing of a different circuit that provides power to the IC 2502 and accesses a different memory address to determine the response provided to a polling radio frequency transceiver.

It should be noted that while the embodiments illustrated and described with reference to FIGS. 24 and 25 have two alternative closed circuits, passive radio frequency transponders may also be implemented along the same lines, but providing more than two alternatives. For example, as described above with reference to FIG. 22C, passive radio frequency tags in accordance with the present invention may have a plurality of possible states, each accessed, for example, by pressing a different button. Such an implementation of the present invention may be useful, for example, as a controller for electronic devices which incorporate a radio frequency transceiver.

In the embodiment described above with reference to FIG. 23, the transponder is not seen and read by a polling transceiver unless a button on the transceiver is pushed to close the switch. In FIGS. 24A and 25, embodiments are illustrated in which one or another circuit is always closed so that a polling transceiver whose field reached the transponder will always receive one or another response, depending on which button is pushed or which position a switch is in. In the embodiment illustrated in FIG. 24B the switch interrupting the signal path from the antenna to the IC has a third position, providing the possibility that the transponder may or may not be powered and read when it comes within the field of a polling transceiver, depending on the switch position.

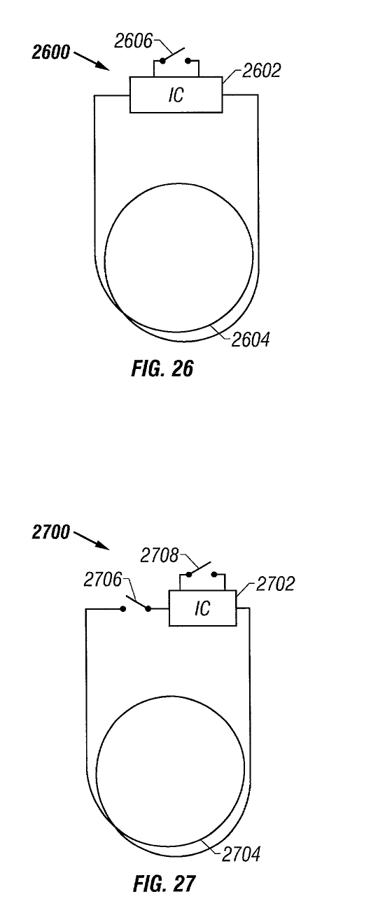

FIG. 26 provides yet another implementation of an interactive transponder. The transponder 2600 includes an IC 2602 and an antenna 2604. There is no switch interrupting the signal path from the antenna to the IC, so the transponder is read whenever it is within the field of a polling transceiver, and a response corresponding to the state of the transponder is provided to the transceiver. The transponder 2600 also has a switch 2606 connected to the IC 2602 which is capable of changing the state of the transponder when closed, for example, by the pushing of a button on the transponder.

FIG. 27 illustrates another embodiment of an interactive transponder. The transponder 2700 combines elements from previously discussed implementations. It includes an IC 2702, an antenna 2704, and a switch 2706 interrupting the signal path from the antenna to the IC. Thus, the transponder may only be read when the switch 2706 is closed, for example, by a button being pushed. In addition, the transponder 2700 also has a switch 2708 connected to the IC 2702 which is capable of changing the state of the transponder when closed, for example, by the pushing of a button on the transponder.

As noted above, it should also be understood that the present invention includes embodiments in which a user interactive interface may provide a variable response (e.g., an “analog switch” as opposed to the discrete response provided by the “digital switches” previously described). Transponders preferably include a transducer and a variable voltage sensor. The transducer converts a user interaction, such as movement on a motion-sensitive pad on the tag, or the pushing of a pressure sensitive pad, into a voltage detected by the variable voltage sensor. The sensor may be configured to detect when a voltage threshold has been reached and cause a change of state in the transponder resulting in a different response being provided to a polling transceiver. Alternatively, real-time response based on the level of user interaction may be provided.

Fixed Position Switches RFID Input Device

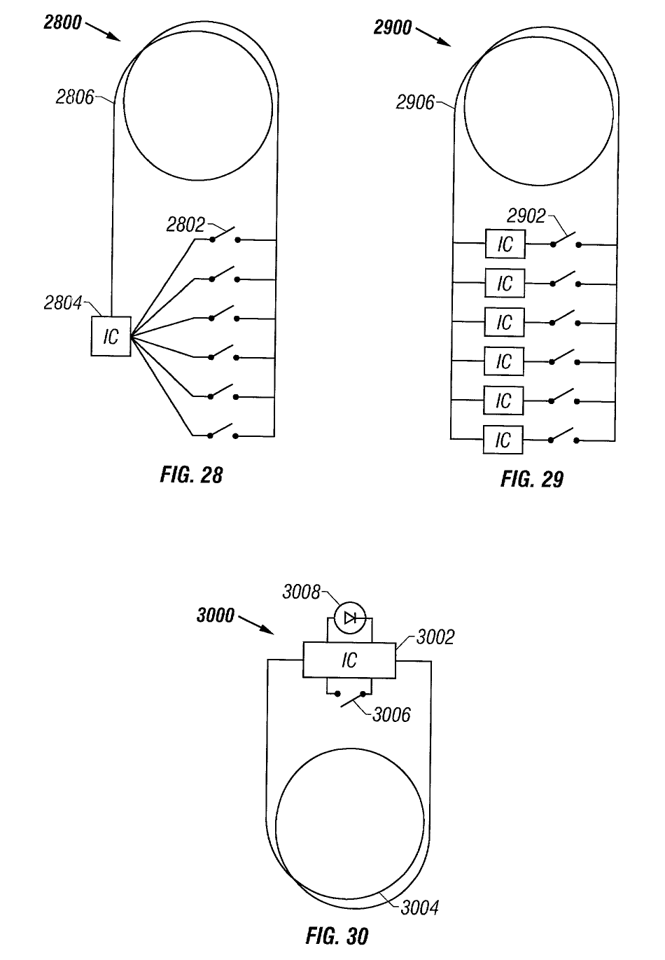

FIG. 28 illustrates an exemplary RFID input device 2800 that is particularly useful for binders, inserts, pads and other products that use fixed position switches as the input device. The RFID input device 2800 comprises a plurality of switches 2802 coupled to an integrated circuit 2804 and an antenna 2806. In operation, when a user activates one of the switches 2802, the integrated circuit 2804 determines which switch has been activated and generates a unique code associated with the activated switch, which is transmitted by the antenna 2806. An RFID reader (not shown in FIG. 28) reads the unique code transmitted by the antenna 2806, which is subsequently communicated to a microprocessor (not shown in FIG. 28) for causing a remote computer, network or other digital device to execute an assigned function.

FIG. 29 illustrates another exemplary RFID input device 2900 that is particularly useful for binders, inserts, pads and other products that use fixed position switches as the input device. The RFID input device 2900 comprises a plurality of switches 2902 coupled to corresponding integrated circuits 2904 and an antenna 2906. In operation, when a user activates one of the switches 2902, the corresponding integrated circuit 2904 generates a unique code associated with the activated switch, which is transmitted by the antenna 2906. An RFID reader (not shown in FIG. 29) reads the unique code transmitted by the antenna 2906, which is subsequently communicated to a microprocessor (not shown in FIG. 29) for causing a remote computer, network or other digital device to execute an assigned function.

Output Tags

In addition, the present invention provides interactive RF tags which visually, audibly, tactilely or otherwise signal a state or change of state of an RF tag in response to a particular external stimulus. The external stimulus may be user intervention with a button on the tag or sensation of an environmental condition received at a separate interface as described above, or may be provided by the RF signal itself received at the tag's antenna as discussed below.

For example, “button” or “sensor” features may be combined with an output feature which visually, audibly, tactilely or otherwise signals the state or change of state of an output RF tag. FIG. 30 illustrates a preferred embodiment which provides an example of such a hybrid output tag. A transponder 3000 has an IC 3002, an antenna 3004, and a switch 3006 on the IC. Thus, the transponder may be read whenever the tag is in the field of an associated transceiver, whether or not the button is pushed. In addition, the transponder 3000 also has an output device 3008 connected to the IC 3002 which is capable of generating a signal when the state of the transponder is changed, for example, by the pushing of a button on the transponder to close the switch 3006.

In a preferred embodiment, the output device may be an LED which lights to indicate a state change. Alternative output devices include speakers which are capable of generating audible signals, such as clicks or beeps, or devices which are capable of generating tactile signals, such as a vibration. Of course, alternative configurations may be used in such output tags. For example, output devices, such as light-emitting diodes (LEDs), may be incorporated into any of the previously described embodiments. Those of skill in the art are familiar with such output devices and, given the principles of the present invention described herein, would be able to fabricate interactive radio frequency transponders in accordance with the present invention.

Another embodiment of a hybrid output tag includes the use of a sensor in place of the switch 3006 of the transponder 3000 illustrated in FIG. 30. According to this embodiment, the state of the transponder would change when a given environmental condition was experienced resulting in the activation of the output device 3008 when the transponder is polled by a transceiver.

An additional novel implementation of an output tag involves the incorporation of an output device, such as an LED, into the circuit of the antenna and IC in a passive transponder, so that a signal is generated when the transponder is powered-up upon exposure to the RF field of a polling transceiver. In this instance, the RF field produced by the polling transceiver provides the external stimulus that causes the change of state in the transponder to produce a signal from the output device. In addition, the RF signal may convey information to change the state of the transponder so that the output device is made to signal or not signal when the transponder is under power.

XI. Applications for the Computer-Interactive Binder and Other Embodiments

There are numerous applications for the computer-interactive binders and other embodiments described herein. This is because the computer-interactive binder is not tied to any specific application, and can be customized for any specific application. A user may choose to create its own unique computer-interactive binder by incorporating physical documents relating to a particular topic and associate that information with electronic information stored in a remote computer, network or other digital devices. In addition, businesses, government entities and educational institutions, for example, may also create application-specific computer-interactive binders for end-users.

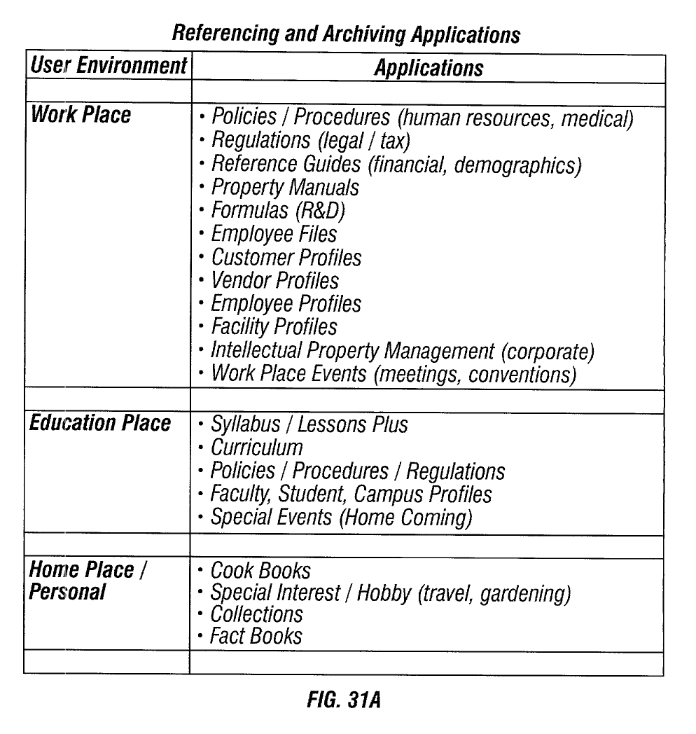

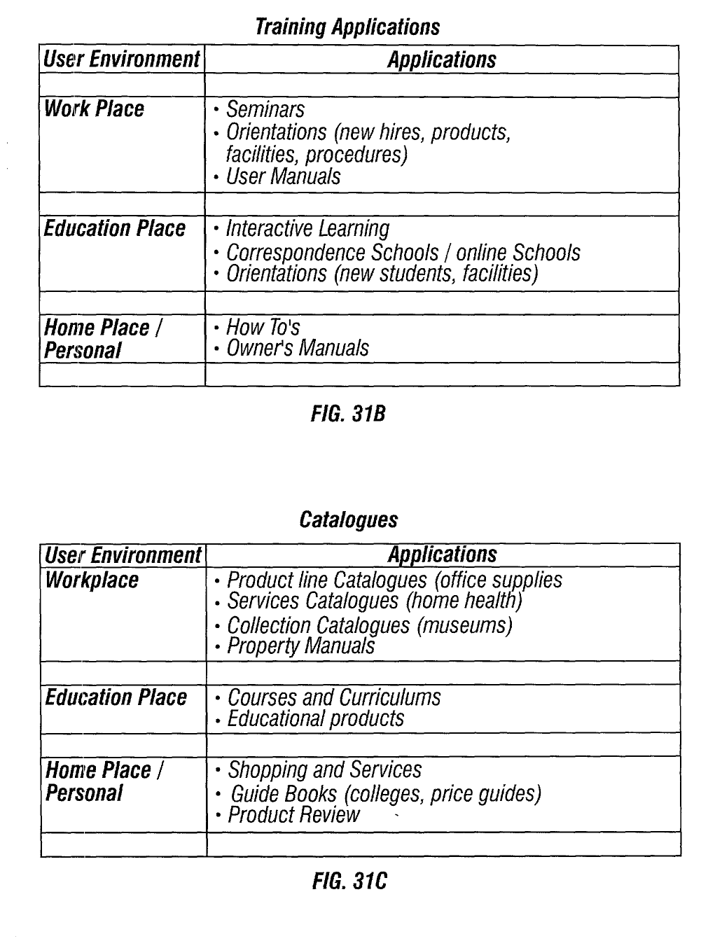

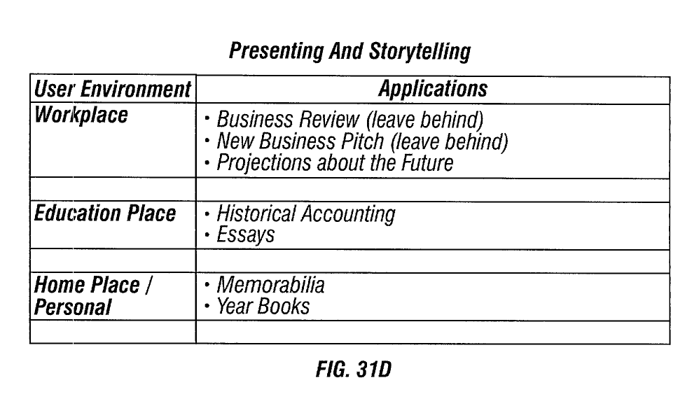

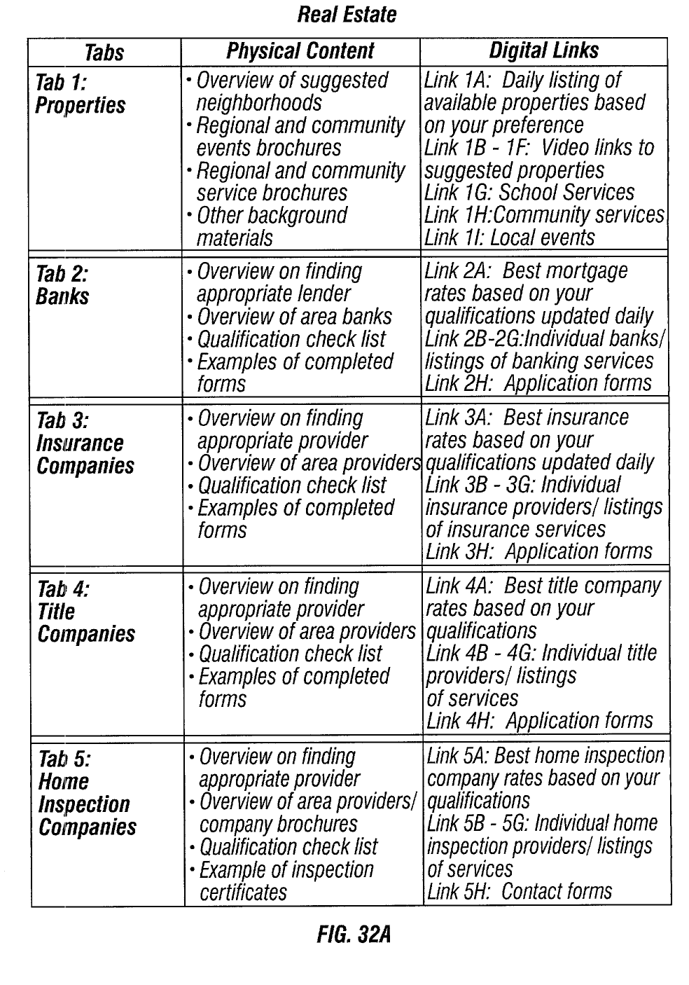

FIG. 31 illustrates examples of broad categories of applications for the computer-interactive binder of the invention. These categories include Referencing and Archiving Applications (FIG. 31A), Training Applications (FIG. 31B), Catalogues (FIG. 31C) and Presenting and Storytelling (FIG. 3 1D). Within each of the broad categories, the applications can be sub-divided into three sub-categories relating to the environment in which the computer-interactive binder is to be used. Such environment sub-categories include Work Environment, Education Environment, and Home/Personal Environment. Each of the environment subcategories may include many different types of applications for the computer-interactive binder.

FIG. 3 1A illustrates an exemplary list of applications for a computer-interactive binder under the broad category of Referencing and Archiving Applications. In the Referencing and Archiving Applications, the focus of the applications is mainly looking up and navigating through electronic information. As previously discussed, the applications within the Referencing and Archiving Category are categorized for the environment in which the computer-interactive binder is to be used. For example, in the Work Environment sub-category, specific applications for the computer-interactive binder may include human resource manuals, such as company policies and procedures. In this particular application, a computer-interactive binder may include organized physical documents that specify a company's policies and procedures, which can be further supplemented by electronic information about the company's policies, procedures or other information with the linking capability of the computer-interactive binder.

Other applications for the computer-interactive binder in the Work Environment sub-category the Referencing and Archiving Applications include government laws, rules and regulations, referencing guides for example regarding financial and demographics, customized real estate binder for prospective buyers, research and development, employee files, customer profiles, vendor profiles, employee profiles, facility profiles, intellectual property portfolios and work place events such as meetings and conventions, to name a few. The different applications that can occupy the Work Environment sub-category of the Referencing and Archiving Applications are too numerous to mention. However, it shall be understood that a computer-interactive binder can be configured in accordance with the broad teachings of the invention so that it can be used for any type of referencing and archiving application for the work environment.

FIG. 3 1A also illustrates an exemplary list of applications for a computer-interactive binder under the Education Environment sub-category of the Referencing and Archiving Applications. For example, in the Education Environment sub-category, specific applications for the computer-interactive binder may include syllabus/lesson plans where, for example, a professor may hand out to each student a computer-interactive binder having a printed syllabus with lesson plans, and a student can access supplemental electronic information concerning homework assignments, additional reading material, and other electronic information relating to the lesson plans with the linking capability of the computer-interactive binder.

Other applications for the computer-interactive binder in the Education Environment includes school curriculum and on-line class registration, school policies, procedures and regulations, faculty, student and campus profiles, and special events such as home coming. The different applications that can occupy the Education Environment sub-category of the Referencing and Archiving Applications are too numerous to mention. However, it shall be understood that a computer-interactive binder can be configured in accordance with the broad teachings of the invention so that it can be used for any type of referencing and archiving application for the education environment.

FIG. 31 A further illustrates an exemplary list of applications for a computer-interactive binder under the Home/Personal Environment sub-category of the Referencing and Archiving Applications. For example, in the Home/Personal Environment sub-category, specific applications for the computer-interactive binder may include cook books where the computer-interactive binder may include a list of recipes organized, for example, into different international cuisine. A user in a home environment can obtain supplemental electronic information regarding the dishes, such as it recipes, the ingredient needed, or historical background on origins of the selected dish with the linking capability of the computer-interactive binder.

Other applications for the computer-interactive binder in the Home/Personal Environment includes special interest/hobbies such as travelling, home improvement, personal financing, collections and fact books, to name a few. The different applications that can occupy the Home/Personal Environment sub-category of the Referencing and Archiving Applications are too numerous to mention. However, it shall be understood that a computer-interactive binder can be configured in accordance with the broad teachings of the invention so that it can be used for any type of referencing and archiving application for the home/personal environment.

FIG. 31 B illustrates an exemplary list of applications for a computer-interactive binder under the broad category of Training Applications. In the Training Applications, the focus of the applications is mainly user stimulus and response involving lots of user interactions, as opposed to merely looking up and navigating through information. As previously discussed, the applications within the Training Application are sub-categorized for the environment in which the computer-interactive binder is to be used. For example, in the Work Environment sub-category, specific applications for the computer-interactive binder may include seminars where a computer-interactive binder may include physical documents relating to the various topics of a seminar, and where supplemental electronic information relating to those various topics can be accessed by a user with the linking capability of the computer-interactive binder.

Other applications for the computer-interactive binder in the Work Environment sub-category of the Training Applications include orientations such as for new hires, new products, facilities and procedures, and user manuals. The different applications that can occupy the Work Environment sub-category of the Training Applications are too numerous to mention. However, it shall be understood that a computer-interactive binder can be configured in accordance with the broad teachings of the invention so that it can be used for any type of training application for the work environment.

FIG. 31 B also illustrates an exemplary list of applications for a computer-interactive binder under the Education Environment sub-category of the Training Applications. For example, in the Education Environment sub-category, specific applications for the computer-interactive binder may include interactive learning tools where, for example, a computer interactive binder may include the physical documents having the daily class lessons, and where tests, quizzes, or other interactive learning activities relating to the class lessons can be accessed by a student with the linking capability of the computer-interactive binder.

Other applications for the computer-interactive binder in the Education Environment includes correspondence schools where interactive learning activities can be remotely accessed by a student or orientations for new students can be interactively accessed by the student to better orient new students. The different applications that can occupy the Education Environment sub-category of the Training Applications are too numerous to mention. However, it shall be understood that a computer-interactive binder can be configured in accordance with the broad teachings of the invention so that it can be used for any type of training application for the education environment.

FIG. 31 B further illustrates an exemplary list of applications for a computer-interactive binder under the Home/Personal Environment sub-category of the Training Applications. For example, in the Home/Personal Environment sub-category, specific applications for the computer-interactive binder may include “How To” books, such as how to build your own deck, or how to landscape your own backyard, and so forth. With this type of application, a computer-interactive binder may have physical documents with information on the “how to” of the topic of the binder. Interactive learning tools relating to the “how to” topic in the form of electronic data can then be accessed by a user with the linking capability of the computer-interactive binder in order to supplement the user's learning process.

Another application for the computer-interactive binder in the Home/Personal Environment includes owner's manuals for various appliances, equipment, and other apparatus in the home environment. The different applications that can occupy the Home/Personal Environment sub-category of the Training Applications are too numerous to mention. However, it shall be understood that a computer-interactive binder can be configured in accordance with the broad teachings of the invention so that it can be used for any type of training application for the home/personal environment.

FIG. 31 C illustrates an exemplary list of applications for a computer-interactive binder under the broad category of Catalogues. In the Catalogues Applications, the focus of the applications is mainly searching, retrieving and organizing. As previously discussed, the applications within the Catalogues Application are sub-categorized for the environment in which the computer-interactive binder is to be used. For example, in the Work Environment sub-category, specific applications for the computer-interactive binder may include product line catalogues such as office supplies, where a computer-interactive binder may include physical documents relating to a particular product line, and where electronic information about the specific products can be accessed by a user with the linking capability of the computer-interactive binder.

Other applications for the computer-interactive binder in the Work Environment sub-category of the Catalogues Applications include services catalogues such as home health, collection catalogues such as for museums, and real estate property catalogues. The different applications that can occupy the Work Environment sub-category of the Catalogues Applications are too numerous to mention. However, it shall be understood that a computer-interactive binder can be configured in accordance with the broad teachings of the invention so that it can be used for any type of catalogues application for the work environment.

FIG. 31 C also illustrates an exemplary list of applications for a computer-interactive binder under the Education Environment sub-category of the Catalogues Applications. For example, in the Education Environment sub-category, specific applications for the computer-interactive binder may include courses and curriculums where, for example, a computer interactive binder may include physical documents listing the available courses and/or curriculum for a particular major. Electronic information relating to the descriptions of the available courses and/or the curriculum for particular majors can be accessed by a student with the linking capability of the computer-interactive binder.

Another application for the computer-interactive binder in the Education Environment includes a catalogue of educational products. The different applications that can occupy the Education Environment sub-category of the Training Applications are too numerous to mention. However, it shall be understood that a computer-interactive binder can be configured in accordance with the broad teachings of the invention so that it can be used for any type of catalogues application for the education environment.

FIG. 31 C farther illustrates an exemplary list of applications for a computer-interactive binder under the Home/Personal Environment sub-category of the Catalogue Applications. For example, in the Home/Personal Environment sub-category, specific applications for the computer-interactive binder may include shopping and services catalogues where, for example, a computer-interactive binder may have physical documents with information relating to a particular stores product and/or services catalogues, and a user can obtain supplemental electronic information regarding the products and/or services with the linking capability of the computer-interactive binder in order to supplement the user's learning process.

Other applications for the computer-interactive binder in the Home/Personal Environment include guide books such as colleges and price guides, and product review. The different applications that can occupy the Home/Personal Environment sub-category of the Catalogues Applications are too numerous to mention. However, it shall be understood that a computer-interactive binder can be configured in accordance with the broad teachings of the invention so that it can be used for any type of catalogues application for the home/personal environment.

FIG. 31D illustrates an exemplary list of applications for a computer-interactive binder under the broad category of Presenting and Story Telling. In the Presenting and Story Telling Applications, the focus of the applications is mainly customizing and interacting visual information in a multimedia fashion to provide presentations and story telling. As previously discussed, the applications within the Presenting and Story Telling Applications are subcategorized for the environment in which the computer-interactive binder is to be used. For example, in the Work Environment sub-category, specific applications for the computer-interactive binder may include business review where a computer-interactive binder may include physical documents relating to visual information to be displayed on an overhead display, and where electronic visual information can be accessed and displayed by a user for an audience with the linking capability of the computer-interactive binder.

Other applications for the computer-interactive binder in the Work Environment sub-category of the Presenting and Story Telling Applications include new business pitch presentations and company's future projection presentations. The different applications that can occupy the Work Environment sub-category of the Presenting and Story Telling Applications are too numerous to mention. However, it shall be understood that a computer-interactive binder can be configured in accordance with the broad teachings of the invention so that it can be used for any type of presenting and story Telling application for the work environment.

FIG. 3 1D also illustrates an exemplary list of applications for a computer-interactive binder under the Education Environment sub-category of the Presenting and Story Telling Applications. For example, in the Education Environment sub-category, specific applications for the computer-interactive binder may include historical accounting where, for example, a computer interactive binder may include physical documents relating to an chronological accounting of a historical event, and related visual electronic information accessed and displayed to an audience by a student and/or professor with the linking capability of the computer-interactive binder.

Another application for the computer-interactive binder in the Education Environment includes a essays. The different applications that can occupy the Education Environment sub-category of the Presenting and Story Telling Applications are too numerous to mention. However, it shall be understood that a computer-interactive binder can be configured in accordance with the broad teachings of the invention so that it can be used for any type of presenting and story telling application for the education environment.

FIG. 31D further illustrates an exemplary list of applications for a computer-interactive binder under the Home/Personal Environment sub-category of the Presenting and Story Telling Applications. For example, in the Home/Personal Environment sub-category, specific applications for the computer-interactive binder may include memorabilia where, for example, a computer-interactive binder may have with information relating to family pictures of particular events, such as one's birthday or a vacation, and electronic visual information relating to the event-in-question can be accessed and displayed to an audience by a user with the linking capability of the computer-interactive binder.

Another application for the computer-interactive binder in the Home/Personal Environment includes year books. The different applications that can occupy the Home/Personal Environment sub-category of the Presenting and Story Telling Applications are too numerous to mention. However, it shall be understood that a computer-interactive binder can be configured in accordance with the broad teachings of the invention so that it can be used for any type of presenting and story telling application for the home/personal environment.

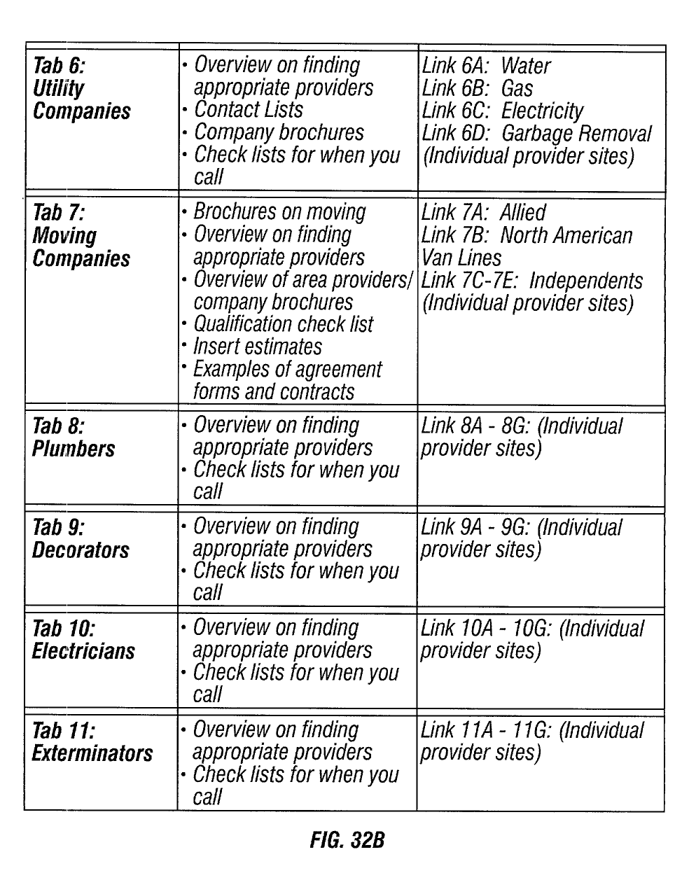

FIG. 32 illustrates a table depicting how a computer-interactive binder in accordance with the invention can be organized for a real estate application. A first column of the table entitled “Tabs” lists the topics of the various tabs (dividers) for the computer-interactive binder. For instance, Tab 1 may be used to categorize information relating to properties, Tab 2 may be used to categorize information relating to Banks, Tab 3 may be used to categorize information relating to insurance companies, Tab 4 may be used to categorize information relating to title companies, Tab 5 may be used to categorize information relating to home inspection companies, Tab 6 may be used to categorize information relating to utility companies, Tab 7 may be used to categorize information relating to moving companies, Tab 8 may be used to categorize information relating to plumbers, Tab 9 may be used to categorize information relating to decorators, Tab 10 may be used to categorize information relating to electricians, and Tab 11 may be used to categorize information relating to exterminators.

A second column of the table entitled “Physical Content” lists physical documents that are associated with corresponding tabs of the computer-interactive binder. For instance, the physical documents associated with Tab 1 (Properties) may include information regarding the overview of a particular neighborhood, regional and community events brochures, regional and community service brochures, and other background materials. Tab 2 (Banks) may include information regarding the overview on finding lenders, overview of local banks, qualification for home loans, and examples of completed home loan applications. Tab 3 (Insurance Companies) may include information regarding the overview on finding appropriate insurance companies, overview of local insurance providers, qualifications for insurance policies, and examples of completed home insurance applications. The remaining physical documents for Tabs 4-11 are listed in the table shown in FIG. 32.

A third column of the table entitled “digital links” lists electronic information related to the corresponding tabs and physical document that can be accessed by a user with the computer-interactive binder. For instance, the electronic information related to Tab 1 (Properties) may include a daily listing of available properties based on a particular buyer's preferences, video links illustrating the suggested properties, school services, community services, and local events. The electronic information related to Tab 2 (Banks) may include the best, up-to-date mortgage rates, listing of individual banks and their available services, and home loan application forms. The electronic information related to Tab 3 (Insurance Companies) may include a list of the best insurance rates based on the borrower's qualifications, listing of individual insurance companies and their available services, and insurance application forms. The remaining “digital links” for Tabs 4-11 are listed in the table shown in FIG. 32.

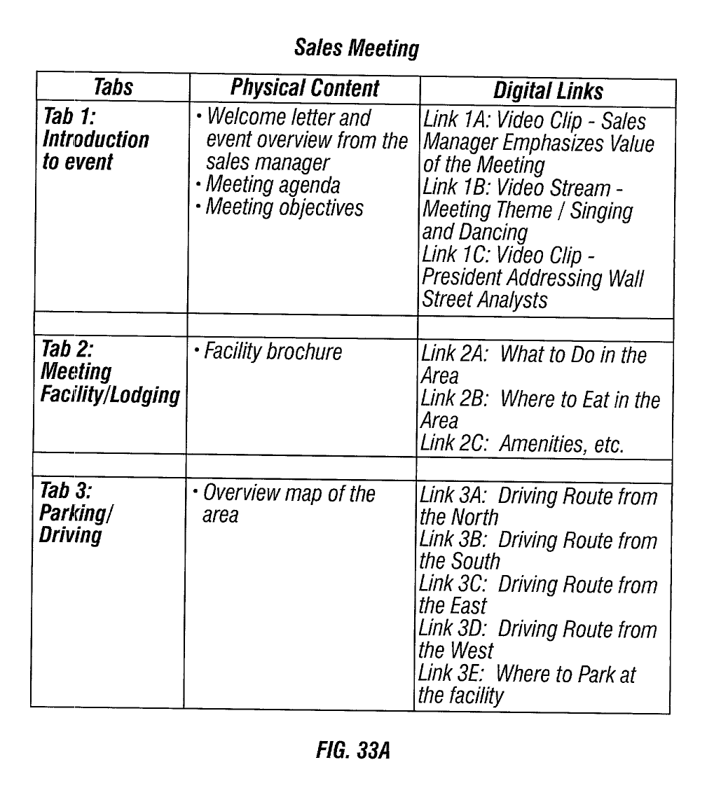

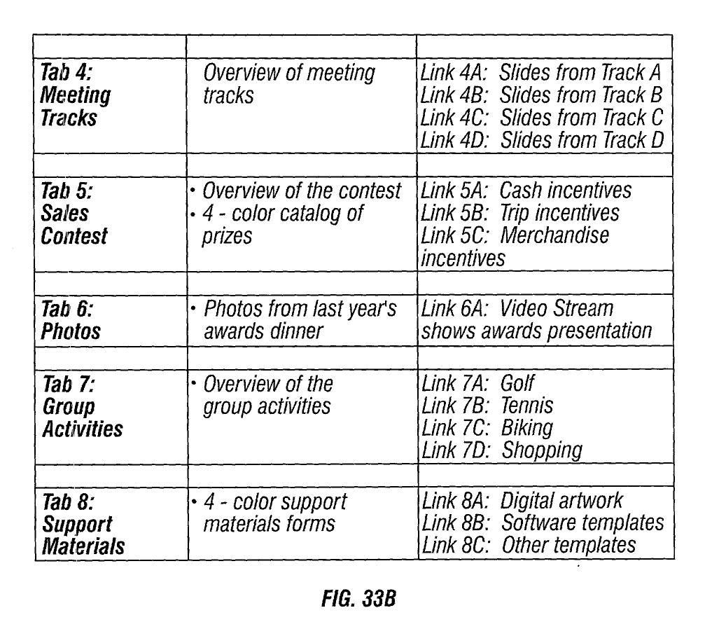

FIG. 33 illustrates a table depicting how a computer-interactive binder in accordance with the invention can be organized for a sales meeting application. The table is organized in a the same fashion as the table depicted in FIG. 32. That is, the “Tabs” column defines the various topics for the sales meeting binder, the “Physical Content” column defines the information on the physical documents related to the topics defined by the corresponding tabs, and the “Digital Links” column defines the electronic information related to the corresponding tabs and physical documents, that can be accessed by a user with the computer-interactive binder. The organization of the computer-interactive binder depicted in FIG. 33 is merely an example of how a computer-interactive binder can be organized for a sales meeting. Those skilled in the art can use the broad teachings of the invention to customize computer-interactive binders for many applications.

XII. High Level Functionality of the Linking Devices

In view of the applications for the computer-interactive binder and other linking devices described herein, it can be seen that the linking devices described herein perform several high level functionality. For instance, the linking devices can be used as an identifier, a locator/accessor, a tracker/monitor, and an organizer, to name a few.

The “identifier” functionality of the linking devices described herein addresses the problem that the burden of accessing the desired digital information is on the user, which at times may be difficult. With the linking device of the invention, the burden of accessing the desired information by the user is reduced. In other words, the linking device “identifies.”

The locator/accessor functionality of the linking devices described herein also addresses the problem that the burden of finding the desired digital information is on the user, which at times may be difficult. With the linking device of the invention, the burden of finding the desired information by the user is reduced. In other words, the linking device “locates.”

The tracker/monitor functionality of the linking devices addresses the problem that it is typically difficult to keep track or monitor information, when the information is constantly changing. With the linking device of the invention, updating and/or monitoring information is improved since electronic information stored accessible from on a website are centrally updated, and thus removes the burden from the user of updating the information on physical documents on the binder. In other words, the linking device “tracks/monitors.”

The organizer functionality of the linking devices addresses the problem that it is sometimes difficult to find and organize digital information. With the linking device of the invention, the electronic information is accessible from a nicely organized indexed scheme. In other words, the linking device is an “organizer” of digital content.

XIII. Customizable Interactive Binder

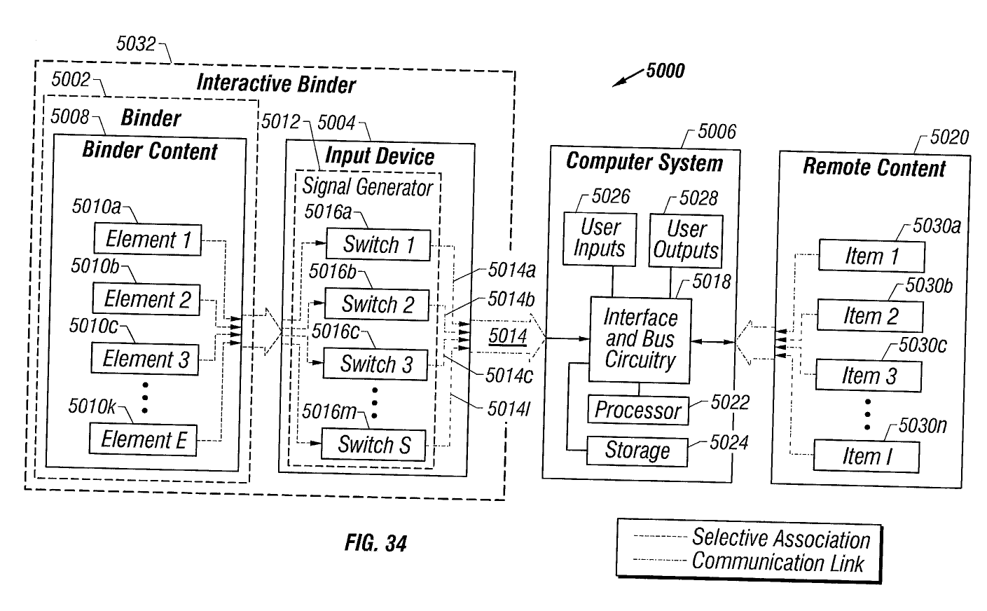

Referencing FIG. 34, a preferred embodiment of an exemplary customizable interactive binder system 5000 that enables a user to customize content into an interactive binder. Exemplary system 500 includes a binder 5002, an input device 5004, and a computer system 5006. Exemplary binder 5002, which may be configured according to any of the embodiments described above, includes binder content 5008 including a plurality of elements 5010a, 5010b, 5010c, . . . , 5010k.

The binder content 5008 may include any type of material that a person may desire to have retained or associated with the binder 5002 and a particular function or application, such as a training binder, an instructional binder, a how-to binder, and so on. For example, the binder content 5008 may include printed sheets of paper, photographs, icons, graphical material, textual material, etc., with each of the elements 5010 representing a piece, a portion, or a section of the binder content 5008.

Exemplary input device 5004, which may be configured according to any of the embodiments described above (e.g., analogous to keyboard 1906 shown in FIG. 19C), includes a signal generator 5012 that, when actuated by a user, generates an access signal. More specifically, exemplary signal generator 5012 is configured to generate one access signal of a plurality of unique access signals 5014a, 5014b, 5014c, . . . , 5014l when actuated by a user. Exemplary signal generator 5012 may include a keypad (not shown) with which a user may type in a combination of one or more keys to generate any number of unique access signals 5012. Alternatively, exemplary signal generator may include one but preferably a plurality of switches 5016a, 5016b, 5016c, . . . , 5016m. Each switch 5016 may be configured to generate a respective one of the access signals 5012 when actuated.

According to the present invention, each of the elements 5010 of the binder content 5008 may be selectively associated with one of the access signals 5014. Alternatively speaking, a unique access signal 5014 may be associated with a respective one of the elements 5010 of the binder content 5008. The selective association between the elements 5010 of the binder content 5008 and the access signals 5014 is represented by the dashed arrows in FIG. 34. This customizable feature of the present invention will be discussed in more detail below.

Exemplary computer system 5006 is configured to be in communication with input device 5004 and to receive access signals 5014. For example, system 5006 may include circuitry for providing interface functions and on-board data control and bus functions, which circuitry is indicated by reference number 5018. The interface circuitry 5018 may be configured to receive either wireless signals or signal transmitted across conventional communication media. The computer system 5006 is also configured to be in communication with remote content 5020. As described in more detail below, exemplary computer system 5006 includes a process 5022 and may include any number of other devices, such a storage device 5024, a user input 5026 (e.g., a keyboard, a mouse, etc.), and an output device 5028 (e.g., a display monitor, a speaker, a printer, etc.).

The remote content 5020 may include any type of material that a person may desire to access. For example, the remote content 5020 may include electronic media that is accessible by a computer, including data files, universal resource locators (URLs), video clips (e.g., MPEG video, etc.), photographs (e.g., GIF, JPEG, etc.), audio clips, web-page addresses, and so on. The remote content 5020 may be located on local storage media (e.g., hard disks, CD-ROMs, etc.) at the computer system 5006 and may be located at remote locations accessible via an network such as a LAN, WAN, intranet, the Internet, etc. Given this wide range of diversity, the remote content 5020 may be divided into a plurality of items 5030a, 5030b, 5030c, . . . , 5030n. Each item 5030 may represent, for example, an image, a video clip, an audio clip, a URL, a web address, a data file, and so on.

According to the present invention, one or more of the elements 5010 of the content 5008 of the binder 5002 is associated with and linked to a respective item 5030 of the remote content 5020. In doing so, a customized interactive binder 5032 is authored by the user for a desired application or function.

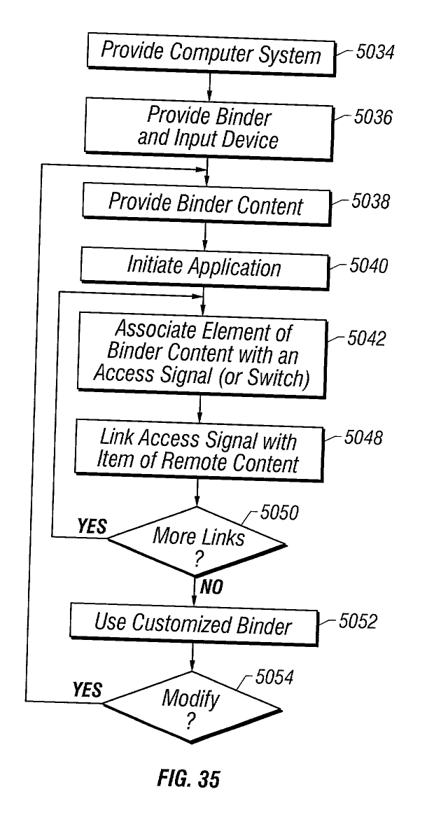

Exemplary methodology for customizing the interactive binder 5032 of the present invention is illustrated in FIG. 35. To customize, a user may first of all provide a computer system 5006 (step 5034) and then a binder 5002 and an input device 5004 (step 5036). The user may then provide any type of binder content 5002 (step 5038) as discussed above. For example, if the interactive binder 5032 is to be customized as a golf training binder, then the binder content 502 may include text and photographs.

A user may then initiate an application (step 5040) on the computer system 5006. The initiation step may include any known method and apparatus for loading and/or running a software application on a computer. The application software that is initiated is configured in accordance with the present invention to cause the computer system 5006 to link the access signals 5014 with items 5030 of the remote content 5020. The application software of the invention may also be configured to cause the computer system 5006 to receive access signals, to retrieve remote content, and to output content for the user, which will be discussed in more detail below.

A user may also associate each element 5010 of the binder content 5002 with a unique access signal 5014 (step 5042). For example, if the input device 5004 is configured in accordance with keyboard 2022 as shown in FIG. 20, then a user may associate a page of content, which may be represented by element 5010a, with access signal 5014a, which, in turn, may be generated by actuating switch 5016a. Continuing with the exemplary preferred embodiment shown in FIG. 20, each of the switches 5016 may represent a signal-generation process where a user depresses switch 1 and then switch A, the combination of which may generate access signal 5014a. Alternatively, exemplary keyboard 2022 may be configured so that a user need only actuate one of the switches A-O.

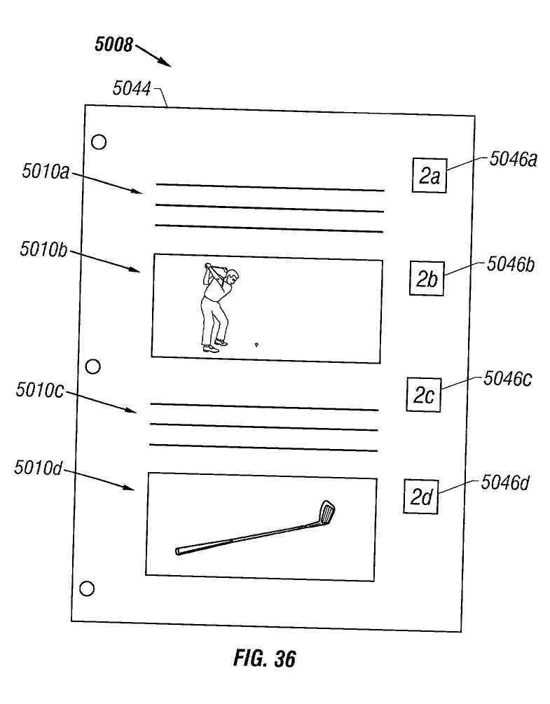

More specifically, as shown in FIG. 36, an embodiment of an example of binder content 5008 is shown for the purposes of this description as a three-hole punched page 5044 for a conventional three-ring binder. The page 5044 includes text and graphics which represent elements 5010 of the content 5008. Each of the elements 5010 is associated with one of the switches 5016 which are represented by tags 5046, that is, element 5010a with tag 5046a, element 5010b with tag 5046b, element 5010c with tag 5046c, and element 5010d with tag 5046d. Each of the tags 5046 is, in turn, associated with a one of the access signals 5014 by, for example, a unique combination of switches 1-8 and switches A-O as shown in FIG. 20. Accordingly, if a user wanted to gain more information, such as a video clip corresponding to element 5010b, then the user may depress switch 2 and switch B on the keyboard 2022, which will be discussed below.

With continued reference to FIG. 35, a user may then cause the computer system 5006 to link each of the access signals 5014 associated with the switches 5016 with respective items 5030 of remote content 5020 (step 5048). To do so, the initiated application may allow a user to enter with the user input 5026 a unique identifier associated with each of the switches 5016 and then enter, for example, a computer-readable address where a particular item 5030 may be accessed. The processor 5022 may then store the unique identifiers in a look-up table in the storage device 5024. Accordingly, when in use and an access signal 5014 is received, the processor 5022 may access the look-up table to determine the location of the item 5030 linked to the received access signal and then retrieve the item for output on the user output 5028.

The process for associating elements 5010 of binder content 5008 with access signals 5016 and then linking access signals 5016 with items 5030 of remote content 5020 may continued (step 5050) until the user has completed customizing the interactive binder 5032, which is then ready for user (step 5052), which is discuss below. If desired, a user may then modify the interactive binder 5032 (step 5054) and re-modify a plurality of times.

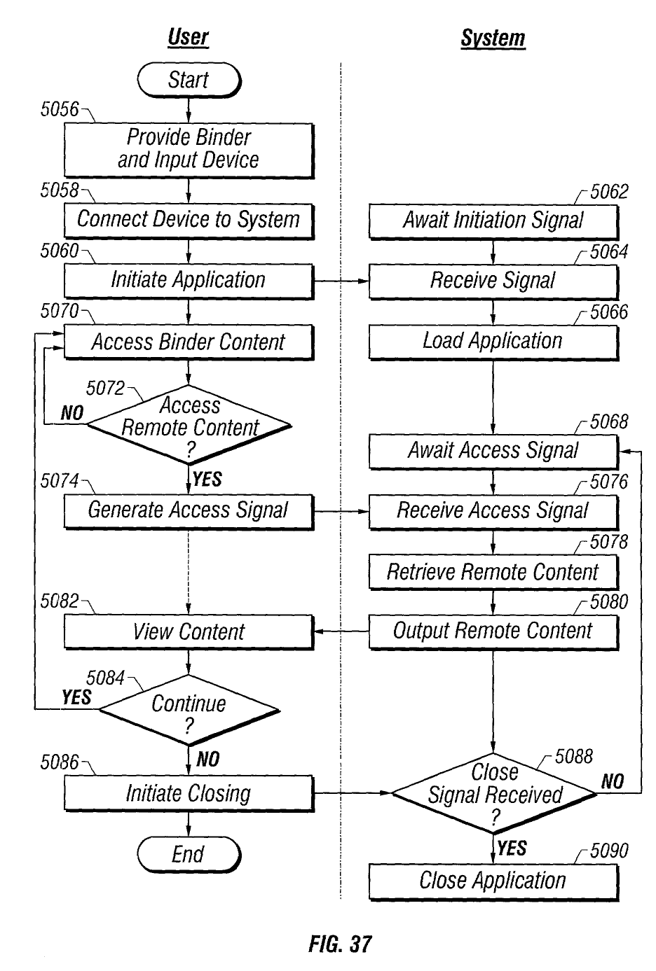

Referencing FIG. 37, to utilize the interactive binder 5032 (step 5056) as customized according to the methodology of the present invention, a user connects the input device50l4 with a computer system 5006 (step 5058). This connection may be either a tethered connection or a wireless connection. The user may then initiate an application (step 5060) of the system 5006, which application is configured to retrieve and output remote content 5020 in response to receiving access signals 5016. The computer system 5006 is configured to await an initiation signal (step 5062) from a user via, for example, the user input 5026, and then, upon receipt of such signal (step 5064), load the application (step 5066). The computer system 5006 is then configured to await the receipt of an access signal 5016 at the interface circuitry 5018 (step 5068).

The user may then access the binder content 5008 at his or her leisure. If the user desires to access remote content 5020 (step 5072) associated with a particular element 5010 of the binder content 5008, for example, for expansion upon a particular element 5010, then the user may generate the access signal 5016 (step 5074) associated with the particular element 5010 of binder content 5008. The access signal 5016 may be generated as discussed above. The computer system 5006 receives the access signal 5016 (step 5076) and then retrieves the item 5030 of remote content 5020 linked with the signal (step 5078). The computer system 5006 then outputs the retrieved item 5030 on one of more of the user outputs 5028 (step 5080), for example, on a display and on a speaker. The user may then view/listen to the output item (step 5082).

The process of accessing binder content 5008 and retrieving items 5030 of remote content 5020 associated with elements 5010 of binder content may continue as desired by the user (step 5084). When desired, the user may initiate the closing of the application (step 5086) which, when received (step 5088), the computer system 5006 closes the application (step 5090).

Exemplary customizable interactive binder 5002 of the present invention has any number of uses and applications, from training to presentation to educational. The system 5000 enables identifying, locating, and accessing content 5020 by a simple “one click” hand operation of the input device 5004. In a preferred training embodiment, exemplary interactive binder 5032 reinforces live training, making such training more memorable and effective. For example, video or audio links can be produced and directed to remind a student what a particular class covered on a particular day. In addition, training may be documented, providing the “emotion around the experience,” and by linking only the most meaningful content.

The interactive binder 5032 of the present invention has a number of advantages. For example, there is a certain degree of intuitiveness about interacting with physical binder content, such as a physical book or manual, which has control over to multimedia or the Internet (versus a keyboard or a mouse). Students can more naturally interact with both hardcopy and digital information while assuming a relaxed, comfortable posture (as opposed to a more rigid or sitting position in front of a PC, mainly deploying one's vision and fingertips). In addition, the interactive binder 5032 employs a number of methods by which people learn effectively: reading, looking at and studying pictures and graphics, watching video, and listening to audio. The customizable interactive binder 5032 engages more of the total body for a fuller, more human-like, kinesthetic learning experience, integrating the best of the training tools used by trainers today: hardcopy manuals, video, and computer-based training.

Moreover, exemplary customizable interactive binder 5032 provides users with superior navigation abilities of paper and access to random video segments without having to spend time fast forwarding or searching for electronic content. Paper provides the ability to randomly access hardcopy information by flipping pages, going back and forth, and skipping around at will. Much like paper, random-access video segments provide the ability to go back and forth and skip around multimedia at will. This behavior supports the way people best learn. The interactive binder 5032 provides users with the opportunity to directly interact with paper, including marking up and jotting down notes. In addition, the binder 5032 may be configured to allow a user to freeze frame multimedia to make a detailed study of video. Having random access to hardcopy and multimedia, the user has complete freedom and flexibility to learn in his or her own individual way.

Although the interactive binder 5032 may be used to reinforce live training experiences and materials, the binder 5032 may also be used as a tool for providing training between live training sessions, thereby successfully abbreviating the amount of required live training. As such, the customizable interactive binder 5032 may save corporations training expenses, including travel and entertainment.

XIII. Conclusion

While the invention has been described in connection with various embodiments, it will be understood that the invention is capable of further modifications. This application is intended to cover any variations, uses or adaptation of the invention following, in general, the principles of the invention, and including such departures from the present disclosure as come within known and customary practice within the art to which the invention pertains.

What is claimed is:

1. A customizable training system comprising:
a binder including binder content having a plurality of elements;
an input device including a switch for being selectively associated with one of the elements of the binder content; and
a computer system in communication with the input device and with remote content including a plurality of items;
the computer system being configured to link the switch with one of the items of remote content so that when the switch is actuated, the linked item of remote content is accessed.

2. A customizable training system as claimed in claim 1 wherein the computer system includes a user output for receiving an accessed item of remote content.

3. A customizable training system as claimed in claim 1 wherein the computer system includes a processor and a user input in communication with the processor;
the user input for generating a link signal when actuated for causing the processor to link the switch of the input device with one of the items of remote content.

4. A customizable training system as claimed in claim 1 wherein the input device includes a plurality of the switches each for being selectively associated with one of the elements of the binder content;
the computer system being configured to link each of the switches with one of the items of remote content so that when a switch is actuated, the linked item of remote content associated with the actuated switch is accessed.

5. A method for customizing a training binder including binder content having a plurality of elements, the method comprising:
providing an input device including a switch for being selectively associated with one of the elements of the binder content;
providing a computer system in communication with the input device and with remote content including a plurality of items;
causing the computer system to link the switch with one of the items of remote content so that when the switch is actuated, the linked item of remote content is accessed.

6. A method as claimed in claim 5 wherein the computer system includes a user output, the method further comprising:
causing the computer system to output an accessed item of remote content at the user output.

7. A method as claimed in claim 5 wherein the computer system includes a processor and a user input in communication with the processor, the method further comprising:
actuating the user input to generate a link signal for causing the processor to link the switch of the input device with one of the items of remote content.

8. A method as claimed in claim 5 wherein the input device includes a plurality of the switches each for being selectively associated with one of the elements of the binder content, the causing step comprising:
causing the computer system to link each of the switches with one of the items of remote content so that when a switch is actuated, the linked item of remote content associated with the actuated switch is accessed.

9. A method for customizing training material with a computer system, the computer system being in communication with remote content including a plurality of items, the method comprising:
providing a binder including binder content having a plurality of elements;
providing an input device in communication with the computer system and including a switch for being selectively associated with one of the elements of the binder content;
linking the switch with one of the items of remote content via the computer system so that when the switch is actuated, the linked item of remote content is accessed by the computer system.

10. A method as claimed in claim 9 wherein the input device includes a plurality of switches each for being selectively associated with one of the elements of the binder content, the linking step comprising:
linking each of the switches with one of the items of remote content via the computer system so that when a switch is actuated, the linked item of remote content associated with the actuated switch is accessed by the computer system.
